(19) United States
(12) Patent Application Publication
(10) Pub. No.: US 2023/0074353 A1
(43) Pub. Date: Mar. 9, 2023

(54) GRADIENT MULTILAYER STRUCTURES FOR A LITHIUM BATTERY, METHODS FOR MANUFACTURING THEREOF, AND LITHIUM BATTERIES COMPRISING GRADIENT MULTILAYER STRUCTURES

(71) Applicant: Ampcera Inc., Milpitas, CA (US)

(72) Inventors: Hui Du, Tucson, AZ (US); James Emery Brown, Tucson, AZ (US); Chen Chen, Tucson, AZ (US); Eongyu Yi, Tucson, AZ (US); Sumin Zhu, Phoenix, AZ (US)

(21) Appl. No.: 17/941,370

(22) Filed: Sep. 9, 2022

Related U.S. Application Data
(60) Provisional application No. 63/242,188, filed on Sep. 9, 2021.

(51) Int. Cl. H01M 4/04; H01M 10/052; H01M 4/36; H01M 4/62

(52) U.S. Cl. CPC H01M 4/0419; H01M 10/052; H01M 4/366; H01M 4/0404; H01M 4/62; H01M 2004/021

(57) ABSTRACT

A gradient multilayer structure for lithium batteries, a method for manufacturing thereof, and a lithium batteries comprise gradient multilayer structures. The multilayer structure has a porosity gradient with respect to adjacent layers of the multilayer structure or a solid-state ionic conductive material gradient with respect to adjacent layers of the multilayer structure.

### PRIORITY

The present application claims the priority of U.S. Provisional Patent Application No. 63/242,188, filed Sep. 9, 2021, which is incorporated herein by reference in its entirety.

### FIELD

The present application relates to the field of multilayer structures for lithium batteries.

### BACKGROUND

Achieving both high energy density and power density is critical for a lithium battery, especially in electric vehicle applications. However, achieving both has been a challenge, typically requiring undesirable tradeoffs.

Accordingly, those skilled in the art continue with research and development in the field of multilayer structures for lithium batteries

### SUMMARY

In one embodiment, there is a method for manufacturing a multilayer structure for a lithium battery, the method comprising: forming a first layer comprising an active material and a first porosity; and forming a second layer on the first layer, the second layer comprising an active material and a second porosity, wherein the first porosity is different from the second porosity. In an aspect, the first layer is formed by energy-assisted spray deposition. In another aspect, the energy-assisted spray deposition comprises thermal spray deposition. In another aspect, the energy-assisted spray deposition comprises cold spray deposition. In another aspect, the first layer is formed on a current collector. In another aspect, the first layer is formed on a negative current collector. In another aspect, the first layer is formed on a positive current collector.

In another embodiment, there is a method for manufacturing a multilayer structure for a lithium battery, in particular a solid-state lithium battery, the method comprising: forming a first layer comprising an active material and a first amount of solid-state ionic conductive material; and forming a second layer on the first layer, the second layer comprising an active material and a second amount of solid-state ionic conductive material, wherein the first amount of solid-state ionic conductive material is different from the second amount of solid-state ionic conductive material. In an aspect, the first layer is formed by energy-assisted spray deposition. In another aspect, the energy-assisted spray deposition comprises thermal spray deposition. In another aspect, the energy-assisted spray deposition comprises cold spray deposition. In another aspect, the first layer is formed on a current collector. In another aspect, the first layer is formed on a negative current collector. In another aspect, the first layer is formed on a positive current collector. In another aspect, the first layer is formed on a solid state electrolyte layer. In another aspect, the solid-state ionic conductive material is a catholyte material. In another aspect, the solid-state ionic conductive material is an anolyte material.

In another embodiment, there is a multilayer structure for a lithium battery, the multilayer structure comprising: a current collector; and a multilayer structure on the current collector, the multilayer structure comprising a plurality of layers comprising an active material and porosity, wherein the multilayer structure has a porosity gradient with respect to adjacent layers of the multilayer structure. In an aspect, the multilayer structure is formed by energy-assisted spray deposition. In another aspect, the energy-assisted spray deposition comprises thermal spray deposition. In another aspect, the energy-assisted spray deposition comprises cold spray deposition. In another aspect, the current collector is a negative current collector. In another aspect, the current collector is a positive current collector.

In another embodiment, there is a multilayer structure for a lithium battery, in particular a solid-state lithium battery, the multilayer structure comprising: a current collector; a multilayer structure on the current collector, the multilayer structure comprising a plurality of layers comprising an active material and a solid-state ionic conductive material, wherein the multilayer structure has a solid-state ionic conductive material gradient with respect to adjacent layers of the multilayer structure. In an aspect, the multilayer structure is formed by energy-assisted spray deposition. In another aspect, the energy-assisted spray deposition comprises thermal spray deposition. In another aspect, the energy-assisted spray deposition comprises cold spray deposition. In another aspect, the current collector is a negative current collector. In another aspect, the current collector is a positive current collector. In another aspect, the multilayer structure further comprises a solid state electrolyte layer between the current collector and the multilayer structure. In another aspect, the solid-state ionic conductive material is a catholyte material. In another aspect, the solid-state ionic conductive material is an anolyte material.

In another embodiment, there is a lithium battery comprising: a first current collector; a second current collector; a porous separator between the first current collector and the second current collector; and a multilayer structure on the first current collector, the multilayer structure comprising a plurality of layers comprising an active material and porosity, wherein the multilayer structure has a porosity gradient with respect to adjacent layers of the multilayer structure.

In another embodiment, there is a lithium battery, in particular a solid-state lithium battery, comprising: a first current collector; a second current collector; a solid state electrolyte between the first current collector and the second current collector; and a multilayer structure on the current collector, the multilayer structure comprising a plurality of layers comprising an active material and an solid-state ionic conductive material, wherein the multilayer structure has a solid-state ionic conductive material gradient with respect to adjacent layers of the multilayer structure.

Other embodiments and aspects of the disclosed gradient multilayer structures for lithium batteries, methods for manufacturing thereof, and lithium batteries comprising gradient multilayer structures will become apparent from the following detailed description, the accompanying drawings and the appended claims.

### BRIEF DESCRIPTION OF THE DRAWINGS

The drawings of the present disclosure further describe exemplary aspects of gradient multilayer structures for lithium batteries, methods for manufacturing thereof, and lithium batteries comprising gradient multilayer structures, according to exemplary embodiments of the present description.

FIG. 1A: A schematic illustration of a first porosity gradient layer of a first exemplary porosity gradient structure, wherein the gradient layer is formed onto a current collector.

FIG. 1B: A schematic illustration of an exemplary porosity gradient structure, wherein a first porosity gradient layer is formed onto a current collector and a second porosity gradient layer is formed onto the first porosity gradient layer.

FIG. 1C: A schematic illustration of an exemplary porosity gradient structure, wherein a first porosity gradient layer is formed onto a current collector, a second porosity gradient layer is formed onto the first porosity gradient layer, and a third porosity gradient layer is formed onto the second porosity gradient layer.

FIG. 2A: A schematic illustration of an exemplary first porosity gradient layer, wherein the gradient layer is formed onto a current collector.

FIG. 2B: A schematic illustration of an exemplary porosity gradient structure, wherein a first porosity gradient layer is formed onto a current collector and a second porosity gradient layer is formed onto the first porosity gradient layer.

FIG. 2C: A schematic illustration of an exemplary porosity gradient structure, wherein a first porosity gradient layer is formed onto a current collector, a second porosity gradient layer is formed onto the first porosity gradient layer, and a third porosity gradient layer is formed onto the second porosity gradient layer.

FIG. 2D: A schematic illustration of an exemplary porosity gradient structure, wherein a first porosity gradient layer is formed onto a current collector, a second porosity gradient layer is formed onto the first porosity gradient layer, and a third porosity gradient layer is formed onto the second porosity gradient layer.

FIG. 3A: A schematic illustration of a first porosity gradient layer of an exemplary porosity gradient structure, wherein the gradient layer is formed onto a current collector.

FIG. 3B: A schematic illustration of an exemplary porosity gradient structure, wherein a first porosity gradient layer is formed onto a current collector, and a second porosity gradient layer is formed onto the first porosity gradient layer.

FIG. 3C: A schematic illustration of an exemplary porosity gradient structure, wherein a first porosity gradient layer is formed onto a current collector, a second porosity gradient layer is formed onto the first porosity gradient layer, and a third porosity gradient layer is formed onto the second porosity gradient layer.

FIG. 4A: A schematic illustration of a first solid-state ionic conductive material gradient layer of a gradient composite structure, wherein the first solid-state ionic conductive material gradient layer is formed onto a current collector.

FIG. 4B: A schematic illustration of a gradient composite structure, wherein a first solid-state ionic conductive material gradient layer is formed onto a current collector and a second solid-state ionic conductive material gradient layer is formed onto the first solid-state ionic conductive material gradient layer.

FIG. 4C: A schematic illustration of a gradient composite structure, wherein a first solid-state ionic conductive material gradient layer is formed onto a current collector, a second solid-state ionic conductive material gradient layer is formed onto the first solid-state ionic conductive material gradient layer, and a third solid-state ionic conductive material gradient layer is formed onto the second the solid-state ionic conductive material gradient layer.

FIG. 5A: A schematic illustration of a solid-state ionic conductive material gradient layer of a gradient composite structure, wherein the solid-state ionic conductive material gradient layer is formed onto a current collector.

FIG. 5B: A schematic illustration of a gradient composite structure, wherein a first solid-state ionic conductive material gradient layer is formed onto a current collector and a second solid-state ionic conductive material gradient layer is formed onto the first solid-state ionic conductive material gradient layer.

FIG. 5C: A schematic illustration of a gradient composite structure, wherein a first solid-state ionic conductive material gradient layer is formed onto a current collector, a second solid-state ionic conductive material gradient layer is formed onto the first solid-state ionic conductive material gradient layer, and a third solid-state ionic conductive material gradient layer is formed onto the second solid-state ionic conductive material gradient layer.

FIG. 6A: A schematic illustration of a first solid-state ionic conductive material gradient composite layer of a gradient composite structure, wherein the first solid-state ionic conductive material gradient layer is formed onto a current collector.

FIG. 6B: A schematic illustration of a gradient composite structure, wherein a first solid-state ionic conductive material gradient layer is formed onto a current collector and a second solid-state ionic conductive material gradient layer is formed onto the first solid-state ionic conductive material gradient layer.

FIG. 6C: A schematic illustration of a gradient composite structure, wherein a first solid-state ionic conductive material gradient layer is formed onto a current collector, a second solid-state ionic conductive material gradient layer is formed onto the first solid-state ionic conductive material gradient layer, and a third solid-state ionic conductive material gradient layer is formed onto the second solid-state ionic conductive material gradient layer.

FIG. 7: A schematic illustration of a roll-to-roll processing method for porosity gradient and solid-state ionic conductive material gradient structures.

FIG. 8A: A schematic illustration of a lithium battery comprising of a porosity gradient structure formed onto a current collector.

FIG. 8B: A schematic illustration of a lithium battery comprising of a porosity gradient structure formed onto a current collector.

FIG. 8C: A schematic illustration of a lithium battery comprising of a porosity gradient structure formed onto a current collector.

FIG. 9A: A schematic illustration of a solid-state lithium battery comprising of a solid-state ionic conductive material gradient composite structure formed onto a current collector.

FIG. 9B: A schematic illustration of a solid-state lithium battery comprising of a solid-state ionic conductive material gradient composite structure formed onto a current collector.

FIG. 9C: A schematic illustration of a solid-state lithium battery comprising of a solid-state ionic conductive material gradient composite structure formed onto a current collector.

### DETAILED DESCRIPTION

The present description relates to a gradient multilayer structure for lithium batteries, to a method of manufacturing the gradient multilayer structure, and to a lithium battery comprising the gradient multilayer structure. In an aspect, the gradient multilayer structure has a porosity gradient to maximize power and energy densities. The gradient multilayer structure may be formed using an energy-assisted or high-throughput spray processing technique. The porosity gradient may be controlled by, for example, particle size, polymer content, spray processing parameters, or a combination thereof. In the following description, the gradient multilayer structure is primarily described with reference to the cathode of a lithium battery. However, in the present invention, the gradient multilayer structure may be applied to the anode of a lithium battery.

The present description also relates to a gradient composite structure for solid-state lithium batteries, to a method of manufacturing the gradient composite structure, and to a lithium battery comprising the gradient composite structure. The gradient composite structure has a solid-state ionic conductive material gradient to maximize power and energy densities. The gradient composite structure may be formed using an energy-assisted or high-throughput spray processing technique. The solid-state ionic conductive material gradient and morphology may be controlled by, for example, active material/solid-state ionic conductive material particle size, the amount of solid-state ionic conductive material, or a combination thereof. In the following description, the gradient composite structure is primarily described with reference to the cathode of a lithium battery and the solid-state ionic conductive material gradient is referenced as a catholyte gradient. However, in the present invention, the gradient composite structure may be applied to the anode of a lithium battery, and the solid-state ionic conductive material gradient may be an anolyte gradient.

Achieving both high energy density and power density is critical for lithium batteries, especially in electric vehicle applications. However, achieving both has been a challenge, typically requiring undesirable tradeoffs. One way to achieve this is to use gradient cathode structure as the positive electrode or a gradient anode structure as the negative electrode.

In lithium batteries a porosity gradient cathode or anode structure can maximize the active cathode or anode surface area (i.e., powder density) while maintaining a high active loading (i.e. energy density). In the gradient structure porosity may be low at the current collector and is gradually increased until max porosity is achieved at the electrolyte interface. The gradient structure may be constructed to facilitate and optimize lithium-ion conduction throughout the cathode or anode layer.

In solid-state lithium batteries a catholyte or anolyte gradient structure can maximize the contact between catholyte or anolyte and active material (i.e. powder density) while maintaining a high active loading (i.e. energy density). In the gradient structure catholyte or anolyte content is low at the current collector and is gradually increased toward the solid-state electrolyte interface. The high catholyte or anolyte content at the outer surface of the composite cathode or anode may reduce the interface impedance at the cathode/solid-state electrolyte interface or anode/solid-state electrolyte interface enabling higher power-rates. The gradient structure may be constructed to facilitate and optimize lithium-ion conduction throughout the composite cathode layer.

The following description primarily focuses on the cathode as the gradient structure. The concepts may also be applied when the anode is the gradient structure.

Gradient structures may be processed using a solvent-free high-throughput spray processing method, wherein gradient structures are constructed layer by layer. Each layer may use a specific dry cathode powder or composite cathode powder formulation that is tuned to optimize performance. The dry processing approach may eliminate the conventional drying and hot calendering methods used in conventional battery electrode processing.

In an embodiment, a lithium battery may be comprised of a porosity gradient cathode structure as the positive electrode.

In an aspect of the embodiment, porosity may be defined as voids or empty space (i.e. pores) between the active cathode materials.

In another aspect of the embodiment, liquid electrolyte may be used to fill the pores in a lithium battery cathode to facilitate ion conduction within the cathode architecture.

In yet another aspect of the embodiment, active cathode materials may be coated with a thin protective layer to enhance chemical stability with the liquid electrolyte.

In yet another aspect of the embodiment, a cathode architecture may be composed of, but not limited to, active cathode materials with or without a protective coating, binding material, and an electronically conducting additive such as carbon black.

In another embodiment, a high-throughput spray process may be used to construct the porosity gradient structure onto a current collector such as, for example, aluminum foil.

In an aspect of the embodiment, a high-throughput spray process may be a dry or solvent-free process that constructs the porosity gradient structure layer by layer.

In another aspect of the embodiment, a dry cathode powder formulation may be sprayed using a high-throughput spray process, wherein the formulation contains, for example, active cathode materials with or without a protective coating, binding material, and an electronically conducting additive such as carbon black

In yet another aspect of the embodiment, a high-throughput spray process may be used to construct a first porosity gradient layer onto a current collector using a dry cathode powder formulation, wherein the first gradient layer has a low porosity.

In yet another aspect of the embodiment, a high-throughput spray process may be used to construct a second porosity gradient layer onto the first porosity gradient layer, wherein the second gradient layer has a higher porosity with respect to the first gradient layer.

In yet another aspect of the embodiment, a high-throughput spray process may be used to construct a third porosity gradient layer onto the second porosity gradient layer, wherein the third gradient layer has a higher porosity with respect to the second gradient layer.

In yet another aspect of the embodiment, subsequent porosity gradient layers may have higher porosity with respect to the previous gradient layer.

In yet another aspect of the embodiment, high-throughput spray processing may eliminate the need for hot calendering typically used to densify electrode layers.

In yet another embodiment, the porosity gradient may be controlled by the particle size of the active cathode material.

In an aspect of the embodiment, dry cathode powder formulations of varying active cathode particle size ranges may be used to form the porosity gradient structure, wherein each porosity gradient layer is formed using a specific cathode powder formulation.

In another aspect of the embodiment, a first porosity gradient layer may be formed onto a current collector using a dry cathode powder formulation with a large particle size range, wherein the active particle size is in the range of, for example, 100≤s≤0.01 μm, wherein the active smaller particles are used to fill the voids between the larger active particles reducing porosity.

In yet another aspect of the embodiment, a second porosity gradient layer may be formed onto the first porosity gradient layer using a dry cathode powder formulation with a smaller active particle size range than that used to form the first gradient layer, wherein the active particle size has a range of, for example, 99≤s≤0.05 μm.

In yet another aspect of the embodiment, a third porosity gradient layer may be formed onto the second porosity gradient layer using a third dry cathode powder formulation with a smaller active particle size range than that used to form the second gradient layer, wherein the active particle size has a range of, for example, 98≤s≤0.1 μm.

In yet another aspect of the embodiment, subsequent porosity gradient layers may be formed using a cathode powder formulation with a smaller active particle size range than that used to form the previous porosity gradient layer.

In yet another embodiment, the porosity gradient may be constructed by adding a degradable polymer into the dry cathode powder formulation.

In an aspect of the embodiment, a polymer may be decomposed or dissolved away after the formation of the cathode structure using either a thermal or chemical treatment leaving behind a porous or scaffold-like structure.

In another aspect of the embodiment, porosity may be controlled by adjusting the amount or percentage of polymer within the dry cathode powder formulation.

In yet another aspect of the embodiment, a first porosity gradient layer may be formed onto the current collector using a dry cathode powder formulation with a low amount of polymer.

In yet another aspect of the embodiment, a second porosity gradient layer may be formed onto the first porosity gradient layer using a dry cathode powder formulation with a higher amount of polymer than that used to form the first gradient layer.

In yet another aspect of the embodiment, a third porosity gradient layer may be formed onto the second porosity gradient layer using a dry cathode powder formulation with a higher amount of polymer than that used to form the second gradient layer.

In yet another aspect of the embodiment, subsequent porosity gradient layers may be formed using a cathode powder formulation with a higher amount of polymer than that used to form the previous porosity gradient layer.

In yet another embodiment, the porosity gradient may be controlled by tuning the temperature of the high-throughput spray process.

In an aspect of the embodiment, the high-throughput spray process may be an energy-assisted spray deposition. The energy-assisted spray deposition may be a high-temperature deposition process in what is referred to in the art as thermal spray deposition or a cold temperature deposition process in what is referred to in the art as cold spray deposition.

In an aspect of the embodiment, the high-throughput spray process may be a high-temperature deposition process in what is referred to in the art as thermal spray deposition. A type of thermal spray deposition may include, for example, plasma spray deposition.

In another aspect of the embodiment, plasma spray deposition may be used to form the porosity gradient structure by tuning the plasma energy.

In yet another aspect of the embodiment, a first porosity gradient layer may be formed using a high plasma energy to molt the active particles forming a dense layered structure on the current collector.

In yet another aspect of the embodiment, a second porosity gradient layer may be formed onto the first porosity gradient layer using a lower plasma energy than that used to form the first gradient layer, forming a less dense or more granular-like layer.

In yet another aspect of the embodiment, a third porosity gradient layer may be formed onto the second porosity gradient layer using a lower plasma energy than that used to form the second gradient layer, forming a less dense or more granular-like layer.

In yet another aspect of the embodiment, subsequent porosity gradient layers may be formed using a lower plasma energy than that used to form the previous porosity gradient layer, wherein each subsequent layer is less dense forming more granular-like layers.

In yet another embodiment, the porosity gradient may be controlled by tuning the pressure or powder flow rate of the high-throughput spray process.

In an aspect of the embodiment, the high-throughput spray process may be a cold temperature deposition process in what is referred to in the art as cold spray deposition. Types of cold spray deposition may include, for example, high-pressure and low-pressure cold spray depositions.

In another aspect of the embodiment, cold spray deposition may be used to form the porosity gradient structure by tuning the pressure or flow rate of the cathode powder formulation.

In yet another aspect of the embodiment, a first porosity gradient layer may be formed using a high pressure or flow rate wherein the cathode powder formulation undergoes plastic deformation forming a dense layered structure on the current collector.

In yet another aspect of the embodiment, a second porosity gradient layer may be formed onto the first porosity gradient layer using a lower pressure or flow rate than that used to form the first gradient layer, forming a less dense, more granular-like layer.

In yet another aspect of the embodiment, a third porosity gradient layer may be formed onto the second porosity gradient layer using a lower pressure or flow rate than that used to form the second gradient layer, forming a less dense, more granular-like layer.

In yet another aspect of the embodiment, subsequent porosity gradient layers may be formed using a lower pressure or flow rate than that used to form the previous porosity gradient layer, wherein each subsequent layer is less dense forming a more granular-like layer.

In yet another aspect of the embodiment, pressure or powder flow rates may also be adjusted in thermal spray depositions to control the porosity gradient.

In yet another embodiment, a solid-state lithium battery may be composed of a catholyte gradient composite cathode structure as the positive electrode.

In an aspect of the embodiment, a catholyte may be defined as a solid-state ionic conducting media within the composite cathode architecture.

In another aspect of the embodiment, a catholyte may be used in a solid-state lithium battery to facilitate ion conduction within the composite cathode architecture.

In yet another aspect of the embodiment, a catholyte gradient composite cathode may have very low to no porosity.

In yet another aspect of the embodiment, active cathode materials may be coated with a thin protective layer to enhance chemical stability with the catholyte material.

In yet another aspect of the embodiment, a composite cathode architecture may be composed of, for example, active cathode materials with or without a protective coating, and one or more solid-state ionic conducting materials. In some instances, binding and an electronically conducting additive materials may be incorporated.

In yet another embodiment, a high-throughput spray process is used to construct the catholyte gradient structure onto a current collector such as, for example, aluminum foil.

In an aspect of the embodiment, a high-throughput spray process may be a dry or solvent-free process.

In another aspect of the embodiment, the high-throughput spray process may be a high temperature deposition process in what is referred to in the art as thermal spray deposition. A type of thermal spray deposition may include, for example, plasma spray deposition.

In yet another aspect of the embodiment, the high-throughput spray process may be a cold temperature deposition process in what is referred to in the art as cold spray deposition. Types of cold spray deposition may include, for example, high-pressure and low-pressure cold spray depositions.

In yet another aspect of the embodiment, the parameters of the high-throughput spray process may be tuned to achieve very low or no porosity.

In yet another aspect of the embodiment, a dry composite cathode powder formulation may be sprayed using a high-throughput spray process, wherein the formulation contains, for example, active cathode materials with or without a protective coating, catholyte, binding material, and an electronically conducting additive such as carbon black

In yet another aspect of the embodiment, a high-throughput spray process may be used to construct a first catholyte gradient layer onto a current collector using a dry composite cathode powder formulation, wherein the first gradient layer has a low amount of catholyte.

In yet another aspect of the embodiment, a high-throughput spray process may be used to construct a second catholyte gradient layer onto the first catholyte gradient layer, wherein the second gradient layer has a higher amount of catholyte with respect to the first gradient layer.

In yet another aspect of the embodiment, a high-throughput spray process may be used to construct a third catholyte gradient layer onto the second catholyte gradient layer, wherein the third gradient layer has a higher amount of catholyte with respect to the second gradient layer.

In yet another aspect of the embodiment, subsequent catholyte gradient layers may have a higher amount of catholyte with respect to the previous gradient layer.

In yet another embodiment, the catholyte gradient may be controlled by the amount of catholyte in the composite cathode powder formulation.

In an aspect of the embodiment, a first catholyte gradient layer may be formed using a first composite cathode powder formulation with a catholyte mass percentage in the range of 70≤p≤0.01%, relative to the active and inactive material masses.

In another aspect of the embodiment, a second catholyte gradient layer may be formed using a second composite cathode powder formulation with a catholyte mass percentage in the range of 75≤p≤0.05%, relative to the active and inactive material masses, wherein the amount of catholyte is higher than that used to form the first catholyte gradient layer.

In yet another aspect of the embodiment, a third catholyte gradient layer may be formed using a third composite cathode powder formulation with a catholyte mass percentage in the range of 80≤p≤0.1%, relative to the active and inactive material masses, wherein the amount of catholyte is higher than that used to form the second catholyte gradient layer.

In yet another aspect of the embodiment, subsequent catholyte gradient layers may be formed using a composite cathode powder formulation with a higher amount of catholyte than that used to form the previous catholyte gradient layer.

In yet another embodiment, the catholyte gradient may be controlled by the amount of catholyte in the composite cathode powder formulation. In addition, the morphology of the catholyte gradient composite cathode structure may be controlled by varying or tuning the particle sizes of the active cathode and catholyte materials

In an aspect of the embodiment, active cathode and catholyte particle sizes may be tuned to further control the morphology of the catholyte gradient composite cathode structure, wherein the active cathode particle size range is narrowed, and the catholyte particle size range is increased in each subsequent catholyte gradient layer.

In another aspect of the embodiment, a first catholyte gradient layer may be formed using a first composite cathode powder formulation with a catholyte mass percentage in the range of 70≤p≤0.01%, relative to the active and inactive material masses. In addition, active cathode and catholyte particle sizes may be in the range of 100≤s≤0.01 μm.

In yet another aspect of the embodiment, a second catholyte gradient layer may be formed using a second composite cathode powder formulation with a catholyte mass percentage in the range of 75≤p≤0.05%, relative to the active and inactive material masses. In addition, active cathode and catholyte particle sizes may be in the range of 99≤s≤0.05 μm and 101≤s≤0.05 μm, respectively.

In yet another aspect of the embodiment, a third catholyte gradient layer may be formed using a third composite cathode powder formulation with a catholyte mass percentage in the range of 80≤p≤0.1%, relative to the active and inactive material masses. In addition, active cathode and catholyte particle sizes may be in the range of 98≤s≤0.1 μm and 102≤s≤0.1 μm, respectively.

In yet another aspect of the embodiment, subsequent catholyte gradient layers may be formed onto the layered structure using a specific composite cathode powder formulation, wherein the amount of catholyte may be increased, active cathode particle size range decreased, and the catholyte particle size range increased with respect to the previous catholyte gradient layer.

The present disclosure relates to materials inside a gradient cathode structure.

Gradient cathode structures may be composed of active cathode materials and inactive materials such as binders and electronically conductive additives.

In the case of a catholyte gradient composite cathode structure, the composite structure may also be composed of an ionically conductive catholyte material.

The present description relates to active cathode materials inside a gradient cathode structure.

Active cathode materials inside a gradient cathode structure may include intercalation material such as, for example, layered YMO₂, Y-rich layered Y₁₊ₓM₁₋ₓO₂, spinel YM₂O₄, olivine YMPO₄, silicate Y₂MSiO₄, borate YMBO₃, tavorite YMPO₄F (where M is Fe, Co, Ni, Mn, Cu, Cr, etc.), (where Y is Li, Na, K, Mg, Zn, Al, etc.), vanadium oxides, sulfur, lithium sulfide, iron sulfide, FeF₃, LiSe.

In the case of a lithium intercalation, active cathode materials may include, for example, lithium iron phosphate (LiFePO₄), lithium cobalt oxide (LiCoO₂), lithium manganese oxide (LiMn₂O₄), and lithium nickel oxide (LiNiO₂), lithium nickel cobalt manganese oxide (LiNiₓCo_{y}Mn_{z}O₂, 0.95≥x≥0.5, 0.3≥y≥0.025, 0.2≥z≥0.025), lithium nickel cobalt aluminum oxide (LiNiₓCo_{y}Al_{z}O₂, 0.95≥x≥0.5, 0.3≥y≥0.025, 0.2≥z≥0.025), lithium nickel manganese spinel (LiNi_{0.5}Mn_{1.5}O₄), etc.

Active cathode materials inside a gradient cathode structure may be single crystal, polycrystalline, or amorphous.

Active cathode material may be coated with a protected layer to enhance chemical stability with an electrolyte or catholyte.

Protective coatings may include, for example, carbon, lithium niobate (LiNbO₃), lithium borate (Li₂B₄O₇), lithium zirconate (Li₂ZrO₃), lithium titanate (Li₄Ti₅O₁₂), aluminum oxide (Al₂O₃) etc.

The present description relates to inactive materials inside a gradient cathode structure.

A gradient cathode may include an inactive binder such as, for example, polyvinylidene fluoride, polyacrylic acid, lotader, carboxymethyl cellulose, styrene-butadiene rubber, sodium alginate, etc.

A gradient cathode may include an inactive electronically conductive additive such as, for example, graphene, reduced graphene oxide, carbon nanotubes, carbon black, Super P, acetylene black, carbon nanofibers or a conductive polymer such as polyaniline, polypyrrole, poly(3,4-ethylenedioxythiophene (PEDOT), polyphenylene vinylene etc.

A gradient cathode may include an inactive metal binding materials that serves as an electronically conductive. Metal binding material may be in the form of, for example, wires, fibers, nanofibers, nanowires, nanorods, microfibers, etc.

Cathode powder and composite cathode powder formulations may contain a small amount of inactive lithium additives such as lithium nitrate or lithium bis(oxalato)borate to serve as of excess lithium source.

The present description relates to catholyte materials inside a catholyte gradient cathode structure.

A catholyte includes or is formed from a solid-state ionic conductive material. A solid-state ionic conductive material can be described as a material that may have the following characteristics:

A solid-state ionic conductive material is a type of material that can selectively allow a specific charged element to pass through under a presence of an electric field or chemical potential, such as concentration differences.

While this solid-state ionic conductive material allows ions to migrate through, it may not allow electrons to pass easily.

The ions may carry 1, 2, 3, 4 or more positive charges. Examples of the charged ions include but not limited to H⁺, Li⁺, Na⁺, K⁺, Ag⁺, Mg²⁺, Zn²⁺, Fe³⁺, Al³⁺, etc.

The ionic conductivity of the corresponding ions is preferably to be >10⁻⁷ S/cm. It is preferably to have lower electrical conductivity (≤10⁻⁷ S/cm).

Examples of the solid-state ionic conductive material include but not limited to a garnet-like structure oxide material with the general formula:

Liₙ[A_{(3-a′-a″)}A′_{(a′)}A″_{(a″)}][B_{(2-b′-b″)}B′_{(b′)}B″_{(b″)}][C(C′_{(c′)}C″_{(c″)}]O₁₂,

a. where A, A′, and A″ stand for a dodecahedral position of the crystal structure, i. where A stands for one or more trivalent rare earth elements, ii. where A′ stands for one or more alkaline earth elements, iii. where A″ stands for one or more alkaline metal elements other than Li, and iv. wherein 0≤a′≤2 and 0≤a″≤1;

b. where B, B′, and B″ stand for an octahedral position of the crystal structure, i. where B stands for one or more tetravalent elements, ii. where B′ stands for one or more pentavalent elements, iii. where B″ stands for one or more hexavalent elements, and iv. wherein 0≤b′, 0≤b″, and b′+b″≤2;

c. where C′ and C″ stand for a tetrahedral position of the crystal structure, i. where C′ stands for one or more of Al, Ga, and boron, ii. where C″ stands for one or more of Si and Ge, and iii. wherein 0≤c′≤0.5 and 0≤c″≤0.4; and

d. wherein n=7+a′+2·a″−b′−2·b″−3·c′−4·c″ and 4.5≤n≤7.5.

In another example, a solid-state ionic conductive material includes perovskite-type oxides such as (Li,La)TiO₃ or doped or replaced compounds.

In yet another example, a solid-state ionic conductive material includes NASICON-structured lithium membrane, such as LAGP (Li₁₋ₓAlₓGe₂₋ₓ(PO₄)₃), LATP (Li₁₊ₓAlₓTi₂₋ₓ(PO₄)₃) and these materials with other elements doped therein.

In yet another example, a solid-state ionic conductive material includes anti-perovskite structure materials and their derivatives, such as the composition of Li₃OCl, Li₃OBr, Li₃OI.

In yet another example, a solid-state ionic conductive material includes Li₃YH₆(H═F, Cl, Br, I) family of materials, Y can be replaced by other rare earth elements.

In yet another example, a solid-state ionic conductive material includes Li₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof.

In yet another example, a solid-state ionic conductive material includes argyrodites materials with the general formula: Li₁₂₋ₘ₋ₓ(MₘY₄²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻═O²⁻, S²⁻, Se²⁻, Te²⁻, or a combination thereof; X⁻═F⁻, Cl⁻, Br⁻, I⁻, or a combination thereof; and x is in the range of 0≤x≤2.

In yet another example, a solid-state ionic conductive material includes argyrodites materials with the general formula: Li₁₈₋₂ₘ₋ₓM₂^{m+}Y₍₉₋ₓ₎₊ₙXₓ, wherein M^{m+}=B³⁺, Ga³⁺, Sb³⁺, Si⁴⁺, Ge⁴⁺, P⁵⁺, As⁵⁺, or a combination thereof; Y²⁻═O²⁻, S²⁻, Se²⁻, Te²⁻, or a combination thereof; X⁻═F⁻, Cl⁻, Br⁻, I⁻, or a combination thereof; and x is in the range of 0≤x≤2.

In yet another example, a solid-state ionic conductive material includes alkali metal halides with the general formula AₐM_{b}^{m+}M′_{b′}^{m′+}X_{a+mb+m′b′}, where A=Li⁺, Na⁺, K⁺, or a combination thereof, X⁻ ═F⁻, Cl⁻, Br⁻, I⁻, or a combination thereof, M^{m+}=Ti²⁺, V²⁺, Cr²⁺, Mn²⁺, Fe²⁺, Co²⁺, Ni²⁺, Cu²⁺, Zn²⁺, Cd²⁺, Mg²⁺, Pb²⁺, Y³⁺, Sc³⁺, Lu³⁺, La³⁺, Al³⁺, Ga³⁺, In³⁺, Er³⁺, Ho³⁺, Ti³⁺, Cr³⁺, V³⁺, Hf⁴⁺, Zr⁴⁺, V⁴⁺Ti⁴⁺, Mo⁴⁺, W⁴⁺, V⁵⁺, Nb⁵⁺, Ta⁵⁺, Cr⁶⁺, Mo⁶⁺, W⁶⁺, etc., and M′^{m+} may be metal with the same valance state as M^{m+} when b′ is greater than 0, or an aliovalent substitution when b′ is greater than 0.

In some instances, a catholyte may be coated onto the active material prior to high-throughput processing, wherein the catholyte-active cathode materials form a core-shell structure. In such an instance, the active cathode materials may be coated with a protective layer.

The present disclosure relates to processing of a gradient cathode structure.

Gradient cathode structures may be processed using a high-throughput spray processing method.

Gradient cathode structures may include, for example, a porosity gradient cathode structure or a catholyte gradient composite cathode structure.

The present description relates to processing of a porosity gradient cathode structure.

A porosity gradient cathode structure may be processed using a dry cathode powder formulation.

A porosity gradient cathode structure may be processed in a layer-by-layer fashion using a high-throughput spray processing method.

A first porosity gradient layer may be formed onto a current collector using a first cathode powder formulation, wherein the first porosity gradient layer is the densest layer within the porosity gradient cathode structure.

A second porosity gradient layer may be formed onto a first porosity gradient layer using a second cathode powder formulation, wherein the second porosity gradient layer has a higher porosity than the first porosity gradient layer.

A third porosity gradient layer may be formed onto a second porosity gradient layer using a third cathode powder formulation, wherein the third porosity gradient layer has a higher porosity than the second porosity gradient layer.

Subsequent porosity gradient layers may be formed onto the layered structure using a specific cathode powder formulation, wherein each subsequent porosity gradient layer has a higher porosity than the previous porosity gradient layer.

Porosity may be controlled by tuning the composition of the dry cathode powder formulation.

In an example, active cathode material particle size may be tuned in order to control the porosity, wherein smaller particles may be used to fill the space between larger particles, reducing layer porosity.

In an aspect of the example, a first porosity gradient layer may be formed using a cathode powder formulation with a wide active material particle size range, wherein the particle size has a range of 100≤s≤0.01 μm, with a preferred range of 50≤s≤0.5 μm.

In another aspect of the example, a second porosity gradient layer may be formed using a cathode powder formulation with a narrower active material particle size range, wherein the particle size has a range of 99≤s≤0.05 μm, with a preferred range of 25≤s≤1.0 μm.

In yet another aspect of the example, a third porosity gradient layer may be formed using a cathode powder formulation with a narrower active material particle size range, wherein the particle size has a range of 98≤s≤0.1 μm, with a preferred range of 15≤s≤2.0 μm.

In yet another aspect of the example, subsequent porosity gradient layers may be formed using a cathode powder formulation with a narrower active material particle size than that used in the previous porosity gradient layer.

In another example, a polymer may be added to the dry cathode powder formulation, wherein once the gradient cathode structure is formed, the polymer may be removed by decomposition or through a chemical treatment, forming a porous of scaffold structure.

In an aspect of the example, a first porosity gradient layer may be formed using a cathode powder formulation with a small percentage of polymer by mass, wherein the polymer has a mass percentage in the range of 70≤p≤0.01%, with a preferred range of 10≤p≤0.1%, relative to the active and inactive cathode materials.

In another aspect of the example, a second porosity gradient layer may be formed using a cathode powder formulation with a higher percentage of polymer by mass, wherein the polymer has a mass percentage in the range of 75≤p≤0.05%, with a preferred range of 15≤p≤0.5%, relative to the active and inactive cathode materials.

In yet another aspect of the example, a third porosity gradient layer may be formed using a cathode powder formulation with a higher percentage of polymer by mass, wherein the polymer has a mass percentage in the range of 80≤p≤0.1%, with a preferred range of 25≤p≤1%, relative to the active and inactive cathode materials.

In yet another aspect of the example, subsequent porosity gradient layers may be formed using a cathode powder formulation with a higher polymer percentage than that used in the previous porosity gradient cathode layer.

The present description relates to processing of a catholyte gradient cathode structure.

A catholyte gradient composite cathode structure may be processed using a dry composite cathode powder formulation.

A catholyte gradient composite cathode structure may have little to no porosity in the range of 20≤p≤0%, with a preferred range of 5≤p≤0%.

A catholyte gradient composite cathode structure may be processed in a layer-by-layer fashion using a high-throughput spray processing method.

A first catholyte gradient layer may be formed onto a current collector using a first composite cathode powder formulation, wherein the first catholyte gradient layer is the lowest catholyte containing layer within the catholyte gradient composite cathode structure.

A second catholyte gradient layer may be formed onto a first catholyte gradient layer using a second composite cathode powder formulation, wherein the second catholyte gradient layer has a higher catholyte content than the first catholyte gradient layer.

A third catholyte gradient layer may be formed onto a second catholyte gradient layer using a third composite cathode powder formulation, wherein the third catholyte gradient layer has a higher catholyte content than the second catholyte gradient layer.

Subsequent catholyte gradient layers may be formed onto the layered structure using a specific composite cathode powder formulation, wherein each subsequent catholyte gradient layer has a higher catholyte content than the previous catholyte gradient layer.

Catholyte content may be controlled by tuning the composition of the composite cathode powder formulations.

In an example, the amount of catholyte may be increased in each subsequent catholyte gradient layer to control the gradient structure. In addition, active cathode and catholyte particle sizes may be tuned to further control the morphology of the catholyte gradient composite cathode structure, wherein the active cathode particle size range is narrowed, and the catholyte particle size range is increased in each subsequent catholyte gradient layer.

In an aspect of the example, a first catholyte gradient layer may be formed using a first composite cathode powder formulation with a catholyte mass percentage in the range of 70≤p≤0.01%, with a preferred range of 30≤p≤0.1%, relative to the active and inactive material masses. In addition, active cathode and catholyte particle sizes may be in the range of 100≤s≤0.01 μm, with a preferred range of 50≤s≤0.5 μm, and 100≤s≤0.01 μm, with a preferred range 5≤s≤0.05 μm, respectively.

In another aspect of the example, a second catholyte gradient layer may be formed using a second composite cathode powder formulation with a catholyte mass percentage in the range of 75≤p≤0.05%, with a preferred range of 35≤p≤0.5%, relative to the active and inactive material masses. In addition, active cathode and catholyte particle sizes may be in the range of 99≤s≤0.05 μm, with a preferred range of 25≤s≤1.0 μm, and 101≤s≤0.05 μm, with a preferred range 15≤s≤0.1 μm, respectively.

In yet another aspect of the example, a third catholyte gradient layer may be formed using a third composite cathode powder formulation with a catholyte mass percentage in the range of 80≤p≤0.1%, with a preferred range of 40≤p≤1%, relative to the active and inactive material masses. In addition, active cathode and catholyte particle sizes may be in the range of 98≤s≤0.1 μm, with a preferred range of 15≤s≤2 μm, and 102≤s≤0.1 μm, with a preferred range 20≤s≤0.5 μm, respectively.

In yet another aspect of the example, subsequent catholyte gradient layers may be formed onto the layered structure using a specific composite cathode powder formulation, wherein the amount of catholyte may be increased, active cathode particle size range decreased, and the catholyte particle size range increased with respect to the previous catholyte gradient layer.

In another example, catholyte content may be increased for each subsequent catholyte gradient layer, wherein active cathode and catholyte particle size ranges remain constant throughout the catholyte gradient composite cathode structure.

In an aspect of the example, a first catholyte gradient layer may be formed using a first composite cathode powder formulation with a catholyte mass percentage in the range of 70≤p≤0.01%, with a preferred range of 30≤p≤0.1%, relative to the active and inactive material masses. In addition, active cathode and catholyte particle sizes may be in the range of 100≤s≤0.01 μm, with a preferred range of 50≤s≤0.5 μm, and 100≤s≤0.01 μm, with a preferred range 15≤s≤0.05 μm, respectively.

In another aspect of the example, a second catholyte gradient layer may be formed using a second composite cathode powder formulation with a catholyte mass percentage in the range of 75≤p≤0.05%, with a preferred range of 35≤p≤0.5%, relative to the active and inactive material masses. In addition, active cathode and catholyte particle sizes may be in the range of 100≤s≤0.01 μm, with a preferred range of 50≤s≤0.5 μm, and 100≤s≤0.01 μm, with a preferred range 15≤s≤0.05 μm, respectively.

In yet another aspect of the example, a third catholyte gradient layer may be formed using a third composite cathode powder formulation with a catholyte mass percentage in the range of 80≤p≤0.1%, with a preferred range of 40≤p≤1%, relative to the active and inactive material masses. In addition, active cathode and catholyte particle sizes may be in the range of 100≤s≤0.01 μm, with a preferred range of 50≤s≤0.5 μm, and 100≤s≤0.01 μm, with a preferred range 15≤s≤0.05 μm, respectively.

In yet another aspect of the example, subsequent catholyte gradient layers may be formed onto the layered structure using a specific composite cathode powder formulation, wherein the amount of catholyte may be increased, and active cathode and catholyte particle size remains constant with respect to the previous catholyte gradient layer.

An alternative example may include first forming a porosity gradient cathode structure using aforementioned examples, wherein an ionic conducting polymer is then infused or infiltrated into the pores of the porosity gradient cathode structure, wherein once the polymer is cured it serves as a catholyte forming a catholyte gradient composite cathode structure.

The present disclosure relates to a high-temperature spray processing method.

A high-temperature spray processing method may include, for example, thermal spray.

Thermal spray may be defined as a coating or spraying technique where a feedstock or dry cathode/composite cathode powder formulation is fed into a thermal zone, where said feedstock is rapidly heated up to a surface molten state or plastically deformable state and accelerated toward and collides with a current collector or gradient cathode structure following the formation of a first gradient cathode layer.

A feedstock may be defined as a dry cathode powder formulation or dry composite cathode powder formulation.

Thermal spray may include variants such as, but not limited to, plasma spray, flame spray, wire arc spray, high velocity oxygen fuel spraying, laser assisted, induction assisted spraying processes, etc.

Thermal spray may also include any other spray process that uses an elevated temperature to melt a dry cathode powder formulation to form a porosity gradient cathode structure or a dry composite cathode powder formulation to form a catholyte gradient composite cathode structure.

In some instances, the materials comprising gradient structures may be welded together using a high energy laser following thermal spray deposition.

Thermal spraying may be done in atmospheric or inert environments. Atmospheric environments may include a dry room.

Inert environments may include, but not limited to nitrogen, helium, argon etc.

Alternatively, thermal spraying may be done under vacuum conditions.

In yet another alternative, thermal spray may be carried out under reactive environment, such as oxygen, H₂S, ozone, or any other necessary reactive gases that can enhance the material performances.

Thermal spraying may be done manually or by use of a robotic system.

The target (i.e. current collector) to be sprayed may be kept at room temperature, heated up, or cooled down.

A thermal spray gun may be used to for a gradient cathode structure in a layer-by-layer fashion, wherein a gradient cathode structure may include a porosity gradient cathode structure or a catholyte gradient cathode structure.

Alternatively, a gradient cathode structure may be processed in a layer-by-layer fashion using two or more thermal spray guns, wherein the two or more thermal spray guns are used in a roll-to-roll process to form the gradient cathode structure, wherein the current collector is the moving component in the roll-to-roll process, wherein a gradient cathode structure may include a porosity gradient cathode structure or a catholyte gradient cathode structure.

A first gradient cathode layer may be formed onto a moving current collector using a first thermal spray gun in a fixed position, wherein a first cathode or composite cathode powder formulation is used to form the first gradient cathode layer. Alternatively, the first thermal spray gun may move in a lateral or side-to-side movement to cover a wider area. In yet another alternative, multiple first thermal spray guns may be used to form the first gradient cathode layer.

A second gradient cathode layer may be formed onto a moving first gradient cathode layer using a second thermal spray gun in a fixed position, wherein a second cathode or composite cathode powder formulation is used to form the second gradient cathode layer. Alternatively, the second thermal spray gun may move in a lateral or side-to-side movement to cover a wider area. In yet another alternative, multiple second thermal spray guns may be used to form the second gradient cathode layer.

A third gradient cathode layer may be formed onto a moving second gradient cathode layer using a third thermal spray gun, wherein a third cathode or composite cathode powder formulation is used to form the third gradient cathode layer. Alternatively, the third thermal spray gun may move in a lateral or side-to-side movement to cover a wider area. In yet another alternative, multiple third thermal spray guns may be used to form the first gradient cathode layer.

Subsequent gradient cathode layers may be formed onto a moving layered structure using a specific cathode or composite powder formulation, wherein each subsequent gradient cathode layer is formed using a one or more specific thermal spray guns that may be in a fixed position or move in a lateral or side-to-side movement.

Alternatively, the current collector may remain in a fixed position and the two or more thermal spray guns move in coordination to form the cathode gradient structure.

The present description relates to porosity control inside a porosity gradient cathode structure using a high-temperature spray processing method.

Plasma spray deposition may be used to form the porosity gradient structure by tuning the plasma energy.

At high plasma energies a densely layered or lamella structure may be formed, forming a low porosity layer.

At low plasma energies a granular structure may be formed, forming a high porosity layer.

A first porosity gradient layer may be formed onto a current collector using plasma spray, wherein a high plasma energy to molt the active particles forming a dense lamella layered structure on the current collector with low porosity.

A second porosity gradient layer may be formed onto the first porosity gradient layer using plasma spray, wherein a medium plasma energy is used to partially molt the active particles forming a mixture of dense lamella and granular structures with higher porosity than the first porosity gradient layer.

A third porosity gradient layer may be formed onto the second porosity gradient layer using plasma spray, wherein a low plasma energy is used to minimally molt the active particles forming granular structures with higher porosity than the second porosity gradient cathode layer.

Subsequent porosity gradient layers may be formed using a lower plasma energy than that used to form the previous porosity gradient layer, wherein each subsequent layer has a more granular structure with higher porosity than the previous porosity gradient layer.

The present disclosure relates to a low-temperature spray processing method.

A low-temperature spray processing method may include, for example, cold spray also known in the art as supersonic particle deposition.

Types of cold spray deposition may include, for example, high-pressure cold spray deposition or low-pressure cold spray deposition.

In cold spray deposition a dry cathode or composite cathode powder formulation undergoes plastic deformation upon impact with the target which includes a current collector or a gradient cathode layer after the formation of the first gradient cathode layer.

In some instances, the materials comprising gradient structures may be welded together using a high energy laser following cold spray deposition.

Cold spraying may be done in atmospheric or inert environments. Atmospheric environments may include a dry room.

Inert environments may include, but not limited to nitrogen, helium, argon etc.

Alternatively, cold spraying may be done under vacuum conditions.

In yet another alternative, cold spray may be carried out under reactive environment, such as oxygen, H₂S, ozone, or any other necessary reactive gases that can enhance the material performances.

Cold spraying may be done manually or by use of a robotic system.

The target (i.e. current collector) to be sprayed may be kept at room temperature, heated up, or cooled down.

A single cold spray gun may be used to for a gradient cathode structure in a layer-by-layer fashion, wherein a gradient cathode structure may include a porosity gradient cathode structure or a catholyte gradient composite cathode structure.

Alternatively, a gradient cathode structure may be processed in a layer-by-layer fashion using two or more cold spray guns, wherein the two or more cold spray guns are used in a roll-to-roll process to form the gradient cathode structure, wherein the current collector is the moving component in the roll-to-roll process, wherein a gradient cathode structure may include a porosity gradient cathode structure or a catholyte gradient composite cathode structure.

A first gradient cathode layer may be formed onto a moving current collector using a first cold spray gun in a fixed position, wherein a first cathode or composite cathode powder formulation is used to form the first gradient cathode layer. Alternatively, the first cold spray gun may move in a lateral or side-to-side movement to cover a wider area. In yet another alternative, multiple first cold spray guns may be used to form the first gradient cathode layer.

A second gradient cathode layer may be formed onto a moving first gradient cathode layer using a second cold spray gun in a fixed position, wherein a second cathode or composite cathode powder formulation is used to form the second gradient cathode layer. Alternatively, the second cold spray gun may move in a lateral or side-to-side movement to cover a wider area. In yet another alternative, multiple second cold spray guns may be used to form the second gradient cathode layer.

A third gradient cathode layer may be formed onto a moving second gradient cathode layer using a third cold spray gun, wherein a third cathode or composite cathode powder formulation is used to form the third gradient cathode layer. Alternatively, the third cold spray gun may move in a lateral or side-to-side movement to cover a wider area. In yet another alternative, multiple third cold spray guns may be used to form the first gradient cathode layer.

Subsequent gradient cathode layers may be formed onto a moving layered structure using a specific cathode or composite powder formulation, wherein each subsequent gradient cathode layer is formed using a one or more specific cold spray guns that may be in a fixed position or move in a lateral or side-to-side movement.

Alternatively, the current collector may remain in a fixed position and the two or more cold spray guns move in coordination to form the cathode gradient structure.

The present description relates to porosity control inside a porosity gradient cathode structure using a low-temperature spray processing method.

Cold spray or supersonic particle deposition may be used to form the porosity gradient structure by tuning the pressure or powder flow rate of the cathode powder formulation.

At high pressures or powder flow rates a densely layered lamella structure may be formed as a result of a high degree of plastic deformation, forming a low porosity layer.

At low pressures or powder flow rates a granular structure may be formed as a result of a low degree of plastic deformation, forming a high porosity layer.

A first porosity gradient layer may be formed onto a current collector using cold spray, wherein a high pressure or powder flow rate is used to achieve a high degree of plastic deformation, forming a dense lamella layered structure with low porosity.

A second porosity gradient layer may be formed onto the first porosity gradient layer using cold spray, wherein lower pressure or powder flow rate is used to achieve a lower degree of plastic deformation, forming a mixture of dense lamella and granular structures with higher porosity than the first porosity gradient layer.

A third porosity gradient layer may be formed onto the second porosity gradient layer using cold spray, wherein a lower pressure or powder flow rate is used to achieve a lower degree of plastic deformation, forming more granular structures with higher porosity than the second porosity gradient layer.

Subsequent porosity gradient layers may be formed using a lower pressure or powder flow rate than that used to form the previous porosity gradient layer, wherein each subsequent layer has a more granular structure with higher porosity than the previous porosity gradient layer.

Alternatively, pressure or powder flow rates may also be adjusted in thermal spray depositions to control the porosity gradient

The present disclosure relates to a lithium battery containing a porosity gradient cathode structure.

In addition to a porosity gradient cathode structure, a lithium battery may contain a liquid-based electrolyte and an anode.

The present description relates to liquid-based electrolyte materials in a lithium battery.

A liquid-based electrolyte in a lithium battery may contain an organic-based solvent. An organic-based solvents may include, for example, ethylene carbonate (EC), fluoroethylene carbonate (FEC), propylene carbonate (PC), ethyl-methyl carbonate (EMC), dimethyl carbonate (DMC), diethyl carbonate (DEC), dimethyl ether (DME), diethylene glycol dimethyl ether (DEGDME), tetraethylene glycol dimethyl ether (TEGDME), 1,3-dioxolane (DOL), and 1-ethyl-3-methylimidazolium chloride and the mixtures of two or more of them.

A liquid-based electrolyte in a lithium battery may contain an ionic conducting salt. Examples of ionic conducting salts may include, for example, lithium bis(trifluoromethanesulfonyl)imide (LiTFSI) and lithium bis(fluorosulfonyl)imide (LiFSI), lithium bis(oxalato)borate (LiBOB), lithium Difluro(oxalato)borate (LiDFOB), LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, LiN(SO₂CF₃)₂), LiNO₃, sodium bis(trifluoromethanesulfonyl)imide (NaTFSI) and sodium bis(fluorosulfonyl)imide (NaFSI), sodium bis(oxalato)borate (NaBOB) Sodium-difluoro(oxalato)borate (NaDFOB), NaSCN, NaBr, NaI, NaAsF₆, NaSO₃CF₃, NaSO₃CH₃, NaBF₄, NaPF₆, NaN(SO₂F)₂, NaClO₄, NaN(SO₂CF₃)₂, NaNO₃, magnesium bis(trifluoromethanesulfonyl)imide (Mg(TFSI)₂) and magnesium bis(fluorosulfonyl)imide (Mg(FSI)₂), magnesium bis(oxalato)borate (Mg(BOB)₂), magnesium Difluro(oxalato)borate (Mg(DFOB)₂), Mg(SCN)₂, MgBr₂, MgI₂, Mg(ClO₄)₂, Mg(AsF₆)₂, Mg(SO₃CF₃)₂, Mg(SO₃CH₃)₂, Mg(BF₄)₂, Mg(PF₆)₂, Mg(NO₃)₂, Mg(CH₃COOH)₂, potassium bis(trifluoromethanesulfonyl)imide (KTF SI) and potassium bis(fluorosulfonyl)imide (KFSI), potassium bis(oxalato)borate (KBOB), potassium Difluro(oxalato)borate (KDFOB), KSCN, KBr, KI, KClO₄, KAsF₆, KSO₃CF₃, KSO₃CH₃, KBF₄, KB(Ph)₄, KPF₆, KC(SO₂CF₃)₃, KN(SO₂CF₃)₂), KNO₃, Al(NO₃)₂, AlCl₃, Al₂(SO₄)₃, AlBr₃, AlI₃, AlN, AlSCN, Al(ClO₄)₃.

A liquid-based electrolyte in a lithium battery may contain a room temperature ionic liquid. A room temperature ionic liquid may include, for example, imidazolium, pyrrolidinium, piperidinium, ammonium, hexafluorophosphate, dicyanamide, tetrachloroaluminate, sulfonium, phosphonium, pyridinium, pyrazolium and thiazolium.

A liquid-based electrolyte in a lithium battery may be in the form of a gel polymer electrolyte. A gel polymer electrolyte may contain an organic based solvent, ionic conducing salt, and a polymer.

A lithium battery may also be comprised of a porous separating material such as, for example, nonwoven fibers, such as cloth, nylon, polyester, glass fiber, glass mats, polymers, such as polyethylene, polypropylene, poly(tetrafluoroethylene, polyvinyl chloride, polyamide, polyolefin, polyacrylonitrile, cellulose, and natural materials, such as wood, rubber, and asbestos. A porous separating materials may serve as an electronically separating barrier between the gradient cathode structure and anode.

The present description relates to anode materials in a lithium battery.

An anode in a lithium battery may contain an active material that interacts with ions through various mechanisms including, but not limited to, intercalation, alloying and conversion.

An active anode material may include, but not limited to, titanium oxide, silicon, tin oxide, germanium, antimony, silicon oxide, iron oxide, cobalt oxide, ruthenium oxide, molybdenum oxide, molybdenum sulfide, chromium oxide, nickel oxide, manganese oxide, carbon-based materials (hard carbons, soft carbons, graphene, graphite's, carbon nanofibers, carbon nanotubes, etc.).

An active anode material may be coated with a protective layer. A protective layer may serve as an artificial solid electrolyte interface enhancing chemical stability.

An anode in a lithium battery may be composed of a binder such as, but not limited to, polyvinylidene fluoride, polyacrylic acid, carboxymethyl cellulose, styrene-butadiene rubber, sodium alginate, etc.

An anode in a lithium battery may include an electrically conductive additive such as, but not limited to, graphene, reduced graphene oxide, carbon nanotubes, carbon black, Super P, acetylene black, carbon nanofibers or a conductive polymer such as polyaniline, polypyrrole, poly(3,4-ethylenedioxythiophene (PEDOT), polyphenylene vinylene etc.

An anode in a lithium battery may contain a lithium metal or lithium metal alloy film. Alloying materials may include, for example, silicon, indium, magnesium, etc.

A lithium metal or lithium metal alloy film may be coated with a protective layer. A protective layer may serve an artificial solid electrolyte interface to enhancing chemical stability. The protective lay may also be used to suppressing dendrite formation.

An anode in a lithium battery may be formed onto a current collector. An example of a current collector may include, for example, copper, nickel, stainless steel, copper foam, nickel foam, stainless steel foam, etc.

In some instances the lithium battery may be devoid of an anode material referred to in the art as an anode-free or anodeless lithium battery.

The present disclosure relates to a solid-state lithium battery containing a catholyte gradient cathode structure.

In addition to a catholyte gradient cathode structure, a solid-state lithium battery may contain a solid-state electrolyte and an anode.

The present description relates to solid-state electrolyte materials in a solid-state lithium battery.

A solid-state electrolyte in a solid-state lithium battery may be a solid-state ceramic or a ceramic/polymer composite.

A ceramic solid-state electrolyte is formed from a solid-state ionic conductive material. A solid-state ionic conductive material can be described as a material that may have the following characteristics:

A solid-state ionic conductive material is a type of material that can selectively allow a specific charged element to pass through under a presence of an electric field or chemical potential, such as concentration differences.

While this solid-state ionic conductive material allows ions to migrate through, it may not allow electrons to pass easily.

The ions may carry 1, 2, 3, 4 or more positive charges. Examples of the charged ions include but not limited to H⁺, Li⁺, Na⁺, K⁺, Ag⁺, Mg²⁺, Zn²⁺, Fe³⁺, Al³⁺, etc.

The ionic conductivity of the corresponding ions is preferably to be >10⁻⁷ S/cm. It is preferably to have lower electrical conductivity (≤10⁻⁷ S/cm).

Examples of the solid-state ionic conductive material include but not limited to a garnet-like structure oxide material with the general formula:

Liₙ[A_{(3-a′-a″)}A′_{(a′)}A″_{(a″})][B_{(2-b′-b″)}B′_{(b′)}B″_{(b″)}][C¹_{(c′)}C″_{(c″)}]O₁₂,

a. where A, A′, and A″ stand for a dodecahedral position of the crystal structure, i. where A stands for one or more trivalent rare earth elements, ii. where A′ stands for one or more alkaline earth elements, iii. where A″ stands for one or more alkaline metal elements other than Li, and iv. wherein 0≤a′≤2 and 0≤a″≤1;

b. where B, B′, and B″ stand for an octahedral position of the crystal structure, i. where B stands for one or more tetravalent elements, ii. where B′ stands for one or more pentavalent elements, iii. where B″ stands for one or more hexavalent elements, and iv. wherein 0≤b′, 0≤b″, and b′+b″≤2;

c. where C′ and C″ stand for a tetrahedral position of the crystal structure, i. where C′ stands for one or more of Al, Ga, and boron, ii. where C″ stands for one or more of Si and Ge, and iii. wherein 0≤c′≤0.5 and 0≤c″≤0.4; and

d. wherein n=7+a′+2·a″−b′−2·b″−3·c′−4·c″ and 4.5≤n≤7.5.

In another example, a solid-state ionic conductive material includes perovskite-type oxides such as (Li,La)TiO₃ or doped or replaced compounds.

In yet another example, a solid-state ionic conductive material includes NASICON-structured lithium membrane, such as LAGP (Li₁₋ₓAlₓGe₂₋ₓ(PO₄)₃), LATP (Li₁₊ₓAlₓTi₂₋ₓ(PO₄)₃) and these materials with other elements doped therein.

In yet another example, a solid-state ionic conductive material includes anti-perovskite structure materials and their derivatives, such as the composition of Li₃OCl, Li₃OBr, Li₃OI.

In yet another example, a solid-state ionic conductive material includes Li₃YH₆(H═F, Cl, Br, I) family of materials, Y can be replaced by other rare earth elements.

In yet another example, a solid-state ionic conductive material includes Li₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof.

In yet another example, a solid-state ionic conductive material includes argyrodites materials with the general formula: Li₁₂₋ₘ₋ₓ(MₘY₄²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻═O²⁻, S²⁻, Se²⁻, Te²⁻, or a combination thereof; X⁻═F⁻, Cl⁻, Br⁻, I⁻, or a combination thereof; and x is in the range of 0≤x≤2.

In yet another example, a solid-state ionic conductive material includes argyrodites materials with the general formula: Li₁₈₋₂ₘ₋ₓM₂^{m+}Y₍₉₋ₓ₎₊ₙXₓ, wherein M^{m+}=B³⁺, Ga³⁺, Sb³⁺, Si⁴⁺, Ge⁴⁺, P⁵⁺, As⁵⁺, or a combination thereof; Y²⁻═O²⁻, S²⁻, Se²⁻, Te²⁻, or a combination thereof; X⁻═F⁻, Cl⁻, Br⁻, I⁻, or a combination thereof; and x is in the range of 0≤x≤2.

In yet another example, a solid-state ionic conductive material includes alkali metal halides with the general formula AₐM_{b}^{m+}M′_{b′}^{m′}X_{a+mb+m′b′}, where A=Li⁺, Na⁺, K⁺, or a combination thereof, X⁻═F⁻, Cl⁻, Br⁻, I⁻, or a combination thereof, M^{m+}=Ti²⁺, V²⁺, Cr²⁺, Mn²⁺, Fe²⁺, Co²⁺, Ni²⁺, Cu²⁺, Zn²⁺, Cd²⁺, Mg²⁺, Pb²⁺, Y³⁺, Sc³⁺, Lu³⁺, La³⁺, Al³⁺, Ga³⁺, In³⁺, Er³⁺, Ho³⁺, Ti³⁺, Cr³⁺, V³⁺, Hf⁴⁺, Zr⁴⁺, V⁴⁺Ti⁴⁺, Mo⁴⁺, W⁴⁺, V⁵⁺, Nb⁵⁺, Ta⁵⁺, Cr⁶⁺, Mo⁶⁺, W⁶⁺, etc., and M′^{m+} may be metal with the same valance state as M^{m+} when b′ is greater than 0, or an aliovalent substitution when b′ is greater than 0.

A ceramic/polymer composite solid-state electrolyte is formed from a solid-state ionic conductive material and a binding polymer.

A binding polymer may include, for example, polyolefins (e.g., polyethylenes, poly(butene-1), poly(n-pentene-2), polypropylene, polytetrafluoroethylene), polyamines (e.g., poly(ethylene imine) and polypropylene imine (PPI)); polyamides (e.g., polyamide (Nylon), poly(ϵ-caprolactam) (Nylon 6), poly(hexamethylene adipamide) (Nylon 66)), polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly (vinyl alcohol), poly(vinyl chloride), poly(vinyl fluoride), poly(2-vinyl pyridine), vinyl polymer, polychlorotrifluoro ethylene, and poly(isohexylcynaoacrylate)); polyacetals; polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some embodiments, the polymer may be selected from poly(n-pentene-2), polypropylene, polytetrafluoroethylene, polyamides (e.g., polyamide (Nylon), poly(ϵ-caprolactam) (Nylon 6), poly(hexamethylene adipamide) (Nylon 66)), polyimides (e.g., polynitrile, and poly(pyromellitimide-1,4-diphenyl ether) (Kapton®) (NOMEX®) (KEVLAR®)), polyether ether ketone (PEEK).

A ceramic/polymer composition solid-state electrolyte may contain an ionic conducting salt. An example of an ionic conducting salt may include, for example, lithium bis(trifluoromethanesulfonyl)imide (LiTFSI) and lithium bis(fluorosulfonyl)imide (LiFSI), lithium bis(oxalato)borate (LiBOB), lithium Difluro(oxalato)borate (LiDFOB), LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, LiN(SO₂CF₃)₂), LiNO₃, sodium bis(trifluoromethanesulfonyl)imide (NaTFSI) and sodium bis(fluorosulfonyl)imide (NaFSI), sodium bis(oxalato)borate (NaBOB) Sodium-difluoro(oxalato)borate (NaDFOB), NaSCN, NaBr, NaI, NaAsF₆, NaSO₃CF₃, NaSO₃CH₃, NaBF₄, NaPF₆, NaN(SO₂F)₂, NaClO₄, NaN(SO₂CF₃)₂, NaNO₃, magnesium bis(trifluoromethanesulfonyl)imide (Mg(TFSI)₂) and magnesium bis(fluorosulfonyl)imide (Mg(FSI)₂), magnesium bis(oxalato)borate (Mg(BOB)₂), magnesium Difluro(oxalato)borate (Mg(DFOB)₂), Mg(SCN)₂, MgBr₂, MgI₂, Mg(ClO₄)₂, Mg(AsF₆)₂, Mg(SO₃CF₃)₂, Mg(SO₃CH₃)₂, Mg(BF₄)₂, Mg(PF₆)₂, Mg(NO₃)₂, Mg(CH₃COOH)₂, potassium bis(trifluoromethanesulfonyl)imide (KTF SI) and potassium bis(fluorosulfonyl)imide (KFSI), potassium bis(oxalato)borate (KBOB), potassium Difluro(oxalato)borate (KDFOB), KSCN, KBr, KI, KClO₄, KAsF₆, KSO₃CF₃, KSO₃CH₃, KBF₄, KB(Ph)₄, KPF₆, KC(SO₂CF₃)₃, KN(SO₂CF₃)₂), KNO₃, Al(NO₃)₂, AlCl₃, Al₂(SO₄)₃, AlBr₃, AlI₃, AlN, AlSCN, Al(ClO₄)₃.

In some instances a solid-state electrolyte may be a solid polymer containing an ionic conducting salt with no solid-state ceramics.

In some instances, a small amount of liquid-based electrolyte may be added to the solid-state lithium battery forming what is referred to in the art as a hybrid lithium battery.

The present description relates to an anode material in a solid-state lithium battery.

An anode for a solid-state lithium battery may be metal-based or a composite anode.

A metal-based anode in a solid-state lithium battery may include, for example, lithium metal or lithium metal alloy film. Alloying materials may include, for example, silicon, indium, magnesium, etc.

A metal-based anode in a solid-state lithium battery may be coated with a protective layer serving as an artificial solid electrolyte interface.

A composite anode in a solid-state lithium battery may be composed of an active anode material, a binder, an electrically conductive additive, and an ionic conducting anolyte.

A composite anode in a solid-state lithium battery may contain an active material that interacts with ions through various mechanisms including, but not limited to, intercalation, alloying and conversion.

An active anode material in a composite anode may include, but not limited to, titanium oxide, silicon, tin oxide, lithium powder, germanium, antimony, silicon oxide, iron oxide, cobalt oxide, ruthenium oxide, molybdenum oxide, molybdenum sulfide, chromium oxide, nickel oxide, manganese oxide, carbon-based materials (hard carbons, soft carbons, graphene, graphite's, carbon nanofibers, carbon nanotubes, etc.).

Active materials in a composite anode may be coated with a protective layer serving as a solid electrolyte interface to enhance chemical stability with an anolyte.

A composite anode may be composed of a binder such as, but not limited to, polyvinylidene fluoride, polyacrylic acid, carboxymethyl cellulose, styrene-butadiene rubber, sodium alginate, etc.

A composite anode may include an electrically conductive additive such as, but not limited to, graphene, reduced graphene oxide, carbon nanotubes, carbon black, Super P, acetylene black, carbon nanofibers or a conductive polymer such as polyaniline, polypyrrole, poly(3,4-ethylenedioxythiophene (PEDOT), polyphenylene vinylene etc.

A composite anode may be composed of an anolyte. An anolyte is formed from a solid-state ionic conductive material. A solid-state ionic conductive material can be described as a material that may have the following characteristics:

A solid-state ionic conductive material is a type of material that can selectively allow a specific charged element to pass through under a presence of an electric field or chemical potential, such as concentration differences.

While this solid-state ionic conductive material allows ions to migrate through, it may not allow electrons to pass easily.

The ions may carry 1, 2, 3, 4 or more positive charges. Examples of the charged ions include but not limited to H⁺, Li⁺, Na⁺, K⁺, Ag⁺, Mg²⁺, Zn²⁺, Fe³⁺, Al³⁺, etc.

The ionic conductivity of the corresponding ions is preferably to be >10⁻⁷ S/cm. It is preferably to have lower electrical conductivity (≤10'S/cm).

Examples of the solid-state ionic conductive material include but not limited to a garnet-like structure oxide material with the general formula:

Liₙ[A_{(3-a′-a″)}A′_{(a′)}A″_{(a″)}][B_{(2-b′-b″)}B′_{(b′)}B″_{(b″)}][C′_{(c′})C″_{(c″)}]O₁₂,

a. where A, A′, and A″ stand for a dodecahedral position of the crystal structure, i. where A stands for one or more trivalent rare earth elements, ii. where A′ stands for one or more alkaline earth elements, iii. where A″ stands for one or more alkaline metal elements other than Li, and iv. wherein 0≤a′≤2 and 0≤a″≤1;

b. where B, B′, and B″ stand for an octahedral position of the crystal structure, i. where B stands for one or more tetravalent elements, ii. where B′ stands for one or more pentavalent elements, iii. where B″ stands for one or more hexavalent elements, and iv. wherein 0≤b′, 0≤b″, and b′+b″≤2;

c. where C′ and C″ stand for a tetrahedral position of the crystal structure, i. where C′ stands for one or more of Al, Ga, and boron, ii. where C″ stands for one or more of Si and Ge, and iii. wherein 0≤c′≤0.5 and 0≤c″≤0.4; and

d. wherein n=7+a′+2·a″−b′−2·b″−3·c′−4·c″ and 4.5≤n≤7.5.

In another example, a solid-state ionic conductive material includes perovskite-type oxides such as (Li,La)TiO₃ or doped or replaced compounds.

In yet another example, a solid-state ionic conductive material includes NASICON-structured lithium membrane, such as LAGP (Li₁₋ₓAlₓGe₂₋ₓ(PO₄)₃), LATP (Li₁₊ₓAlₓTi₂₋ₓ(PO₄)₃) and these materials with other elements doped therein.

In yet another example, a solid-state ionic conductive material includes anti-perovskite structure materials and their derivatives, such as the composition of Li₃OCl, Li₃OBr, Li₃OI.

In yet another example, a solid-state ionic conductive material includes Li₃YH₆(H═F, Cl, Br, I) family of materials, Y can be replaced by other rare earth elements.

In yet another example, a solid-state ionic conductive material includes Li₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof.

In yet another example, a solid-state ionic conductive material includes argyrodites materials with the general formula: Li₁₂₋ₘ₋ₓ(MₘY₄²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻═O₂⁻, S²⁻, Se²⁻, Te²⁻, or a combination thereof; X⁻═F⁻, Cl⁻, Br⁻, I⁻, or a combination thereof; and x is in the range of 0≤x≤2.

In yet another example, a solid-state ionic conductive material includes argyrodites materials with the general formula: Li₁₈₋₂ₘ₋ₓM₂^{m+}Y₍₉₋ₓ₎₊ₙXₓ, wherein M^{m+}=B³⁺, Ga³⁺, Sb³⁺, Si⁴⁺, Ge⁴⁺, P⁵⁺, As⁵⁺, or a combination thereof; Y²⁻═O²⁻, S²⁻, Se²⁻, Te²⁻, or a combination thereof; X⁻═F⁻, Cl⁻, Br⁻, I⁻, or a combination thereof; and x is in the range of 0≤x≤2.

In yet another example, a solid-state ionic conductive material includes alkali metal halides with the general formula AₐM_{b}^{m+}M′_{b′}^{m′+}X_{a+mb+mb′}, where A=Li⁺, Na⁺, K⁺, or a combination thereof, X⁻ ═F⁻, Cl⁻, Br⁻, I⁻, or a combination thereof, M^{m+}=Ti²⁺, V²⁺, Cr²⁺, Mn²⁺, Fe²⁺, Co²⁺, Ni²⁺, Cu²⁺, Zn²⁺, Cd²⁺, Mg²⁺, Pb²⁺, Y³⁺, Sc³⁺, Lu³⁺, La³⁺, Al³⁺, Ga³⁺, In³⁺, Er³⁺, Ho³⁺, Ti³⁺, Cr³⁺, V³⁺, Hf⁴⁺, Zr⁴⁺, V⁴⁺Ti⁴⁺, Mo⁴⁺, W⁴⁺, V⁵⁺, Nb⁵⁺, Ta⁵⁺, Cr⁶⁺, Mo⁶⁺, W⁶⁺, etc., and M′^{m+} may be metal with the same valance state as M^{m+} when b′ is greater than 0, or an aliovalent substitution when b′ is greater than 0.

A composite anode may be formed onto a current collector. An example of a current collector may include, for example, copper, nickel, stainless steel, etc.

In some instances the solid-state lithium battery may be devoid of an anode material referred to in the art as anode-free or anodeless solid-state lithium battery.

The drawing of the present disclosure further describes examples of gradient cathode structure.

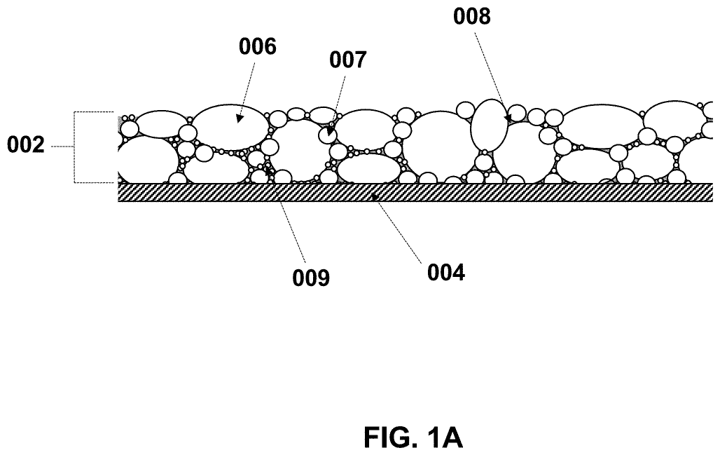

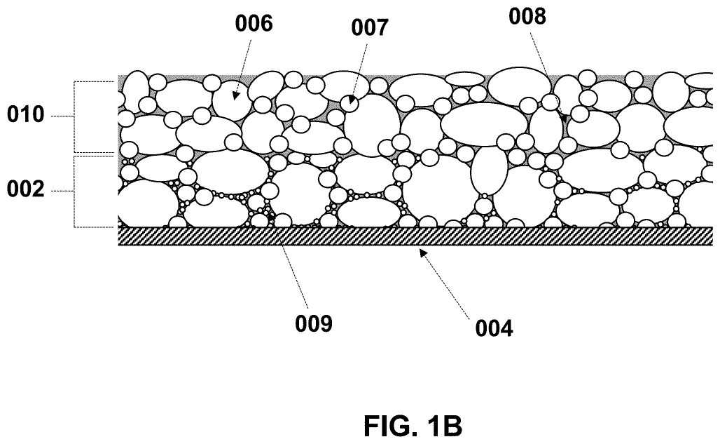

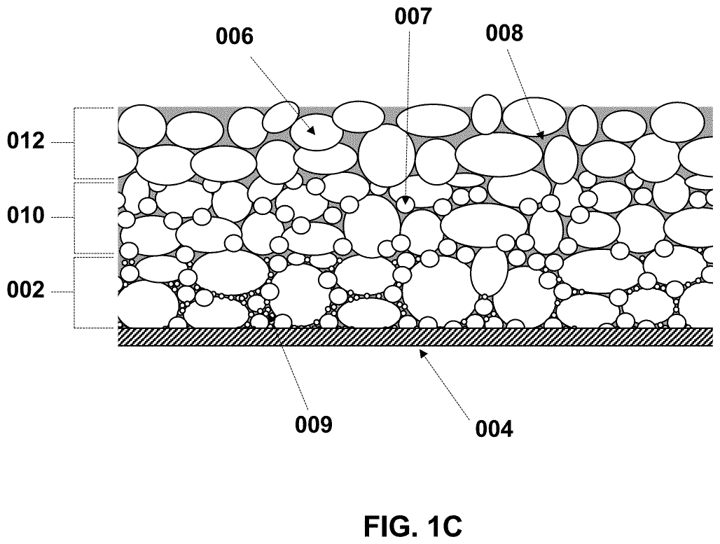

FIG. 1A: A schematic illustration of a first porosity gradient layer (002), wherein the gradient layer is formed onto a current collector (004), wherein the first porosity gradient layer is formed using a dry cathode powder formulation with a wide active cathode material particle size range, wherein the space between large (006) and medium (007) size active particles are filled with smaller active particles (009), resulting in minimal porosity (008).

FIG. 1B: A schematic illustration of porosity gradient cathode structure, wherein a first porosity gradient layer (002) is formed onto a current collector (004) and a second porosity gradient layer (010) is formed onto the first porosity gradient layer, wherein the second porosity gradient layer is formed using a cathode powder formulation with a narrower active cathode material particle size range, with respect to the first porosity gradient layer, wherein the second porosity gradient layer is composed of large (006) and medium (007) sized active materials and has a higher porosity (008) than the first porosity gradient layer.

FIG. 1C: A schematic illustration of a porosity gradient cathode structure, wherein a first porosity gradient layer (002) is formed onto a current collector (004), a second porosity gradient layer (010) is formed onto the first porosity gradient layer, and a third porosity gradient layer (012) is formed onto the second porosity gradient layer, wherein the third porosity gradient layer is formed using a cathode powder formulation with a narrower active cathode material particle size range, with respect to the second porosity gradient layer, wherein the third porosity gradient layer is composed of large (006) sized active materials and has a higher porosity (008) than the second porosity gradient layer.

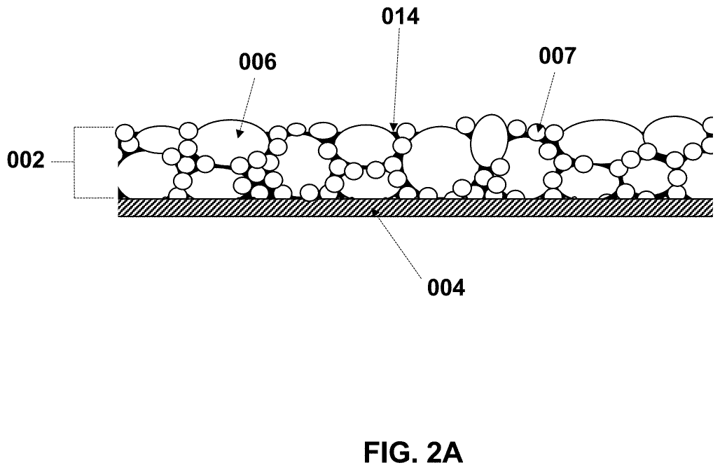

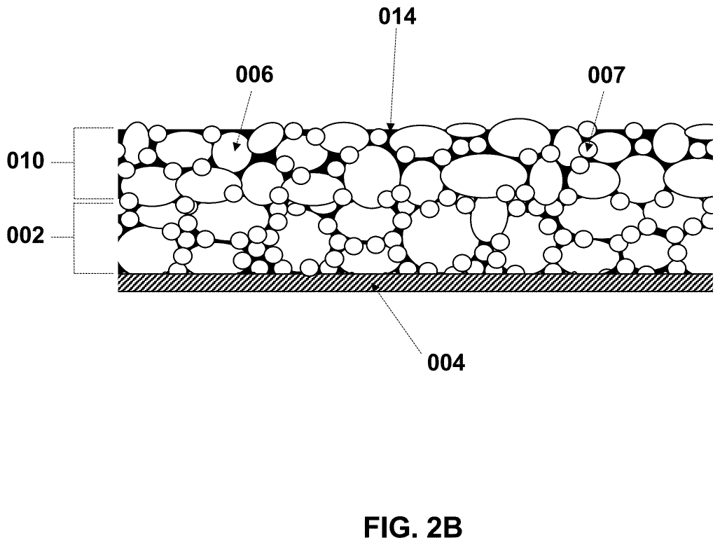

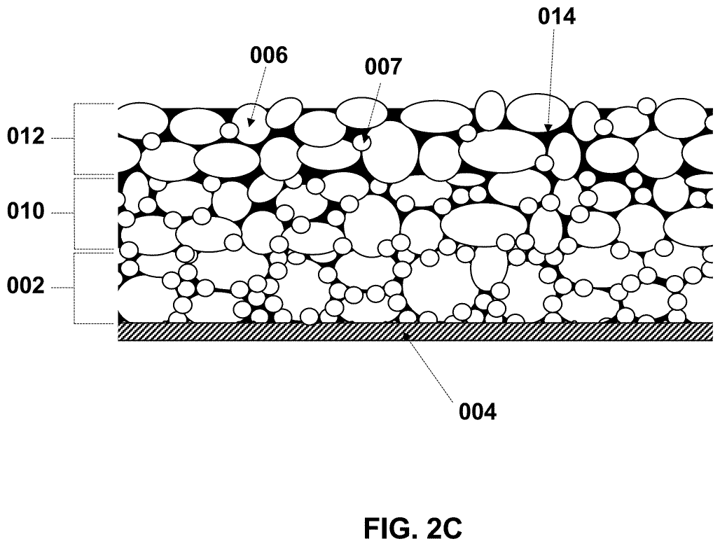

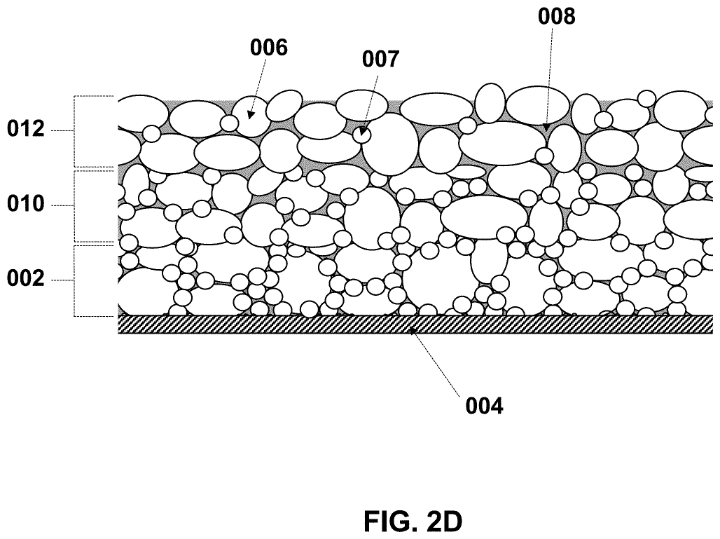

FIG. 2A: A schematic illustration of a polymer filled first porosity gradient cathode layer (002), wherein the gradient layer is formed onto a current collector (004), wherein the first porosity gradient layer is formed using a cathode powder formulation with a low polymer (014) loading, wherein the layer is composed of large (006) and medium (007) sized active particles, and the space between the particles is filled with the polymer (014).

FIG. 2B: A schematic illustration of a polymer filled gradient cathode structure, wherein a first porosity gradient layer (002) is formed onto a current collector (004) and a second porosity gradient layer (010) is formed onto the first porosity gradient layer, wherein the second porosity gradient layer is formed using a cathode powder formulation with a higher polymer (014) loading than the first porosity gradient layer, wherein the second porosity gradient layer is composed of large (006) and medium (007) size active particles, and the space between the particles is filled with the polymer.

FIG. 2C: A schematic illustration of a polymer filled gradient cathode structure, wherein a first porosity gradient layer (002) is formed onto a current collector (004), a second porosity gradient layer (010) is formed onto the first porosity gradient layer, and a third porosity gradient layer (012) is formed onto the second porosity gradient layer, wherein the third porosity gradient layer is formed using a cathode powder formulation with a higher polymer (014) loading than the second porosity gradient layer, wherein the third porosity gradient layer is composed of large (006) and medium (007) size active particles, and the space between the particles is filled with the polymer.

FIG. 2D: A schematic illustration of porosity gradient cathode structure, wherein a first porosity gradient layer (002) is formed onto a current collector (004), a second porosity gradient layer (010) is formed onto the first porosity gradient layer, and a third porosity gradient layer (012) is formed onto the second porosity gradient layer, wherein the polymer has been decomposed forming a porous (008) cathode architecture.

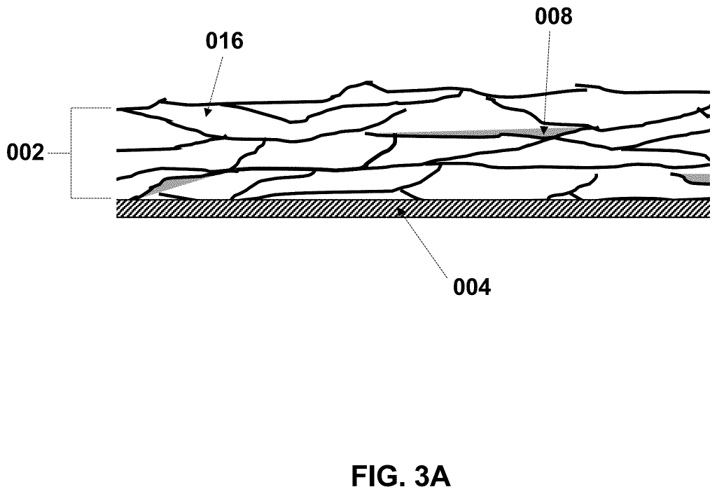

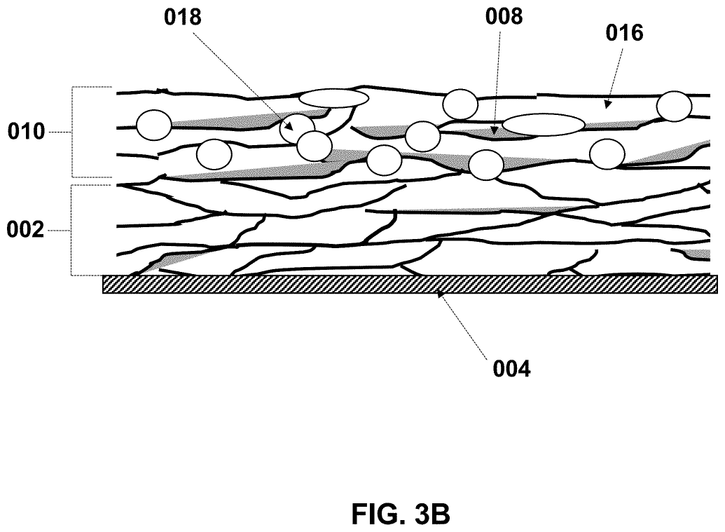

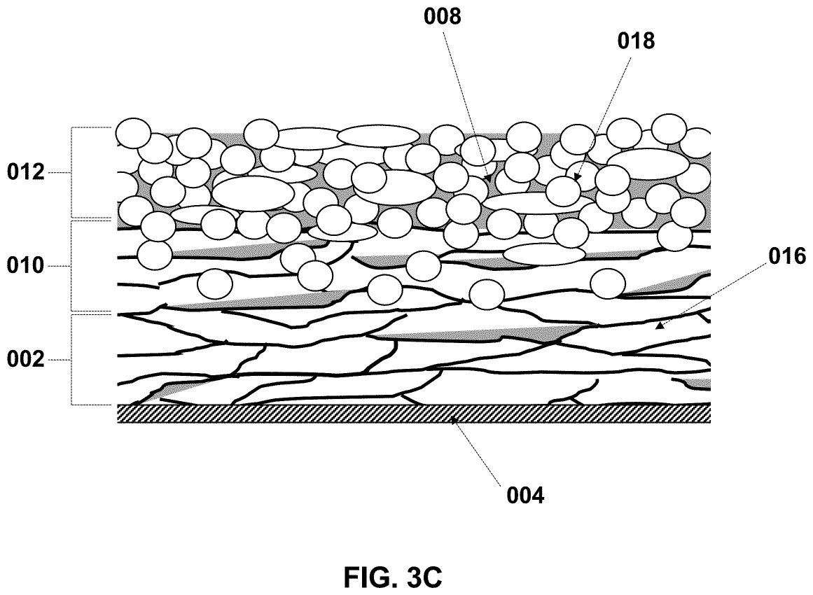

FIG. 3A: A schematic illustration of a first porosity gradient layer (002), wherein the gradient layer is formed onto a current collector (004), wherein the first porosity gradient layer is composed of densely layered active materials (016) within minimal porosity (008), wherein the dense layered is formed using a high plasma energy (via plasma spray) or a high pressure or powder flow rates (via cold spray).

FIG. 3B: A schematic illustration of a porosity gradient cathode structure, wherein a first porosity gradient layer (002) is formed onto a current collector (004), and a second porosity gradient layer (010) is formed onto the first porosity gradient layer, wherein the second porosity gradient layer has both densely layered or lamella active material (016) and active material in granular form (018), wherein the mixed layer has a higher porosity and is formed using a lower plasma energy (via plasma spray) or a lower pressure or powder flow rate (via cold spray) than the first porosity gradient layer.

FIG. 3C: A schematic illustration of a porosity gradient cathode structure, wherein a first porosity gradient layer (002) is formed onto a current collector (004), a second porosity gradient layer (010) is formed onto the first porosity gradient layer, and a third porosity gradient layer (012) is formed onto the second porosity gradient layer, wherein the third porosity gradient layer is composed of active material in granular form (018), wherein granular layer has a high porosity and is formed using a lower plasma energy (via plasma spray) or a lower pressure or powder flow rate (via cold spray) than the second porosity gradient layer.

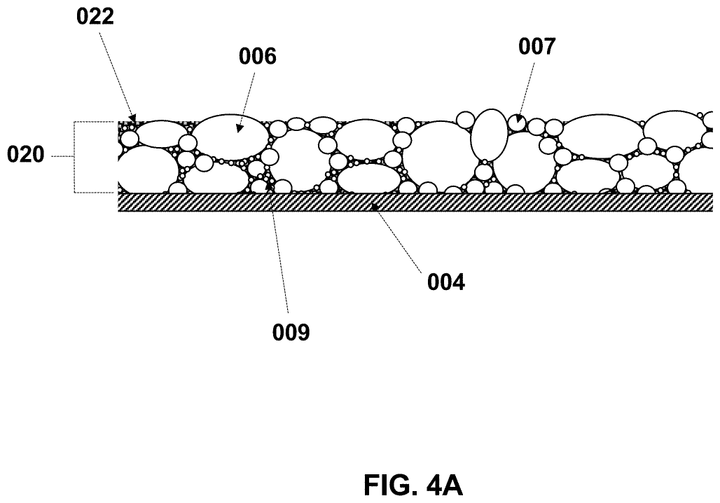

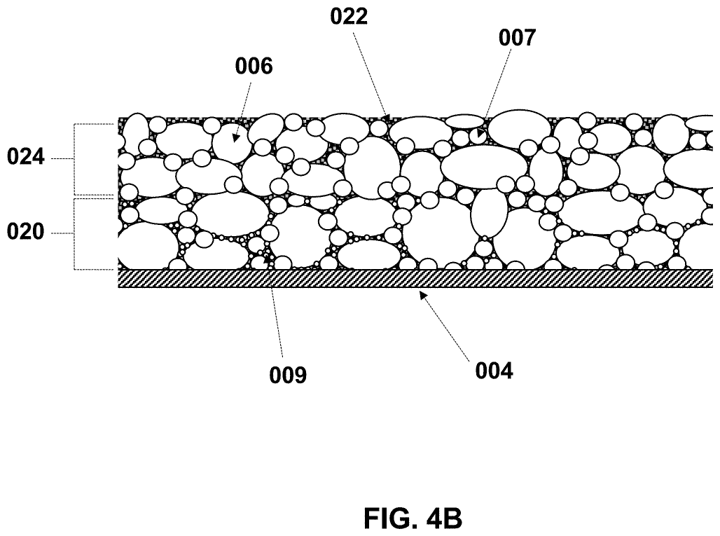

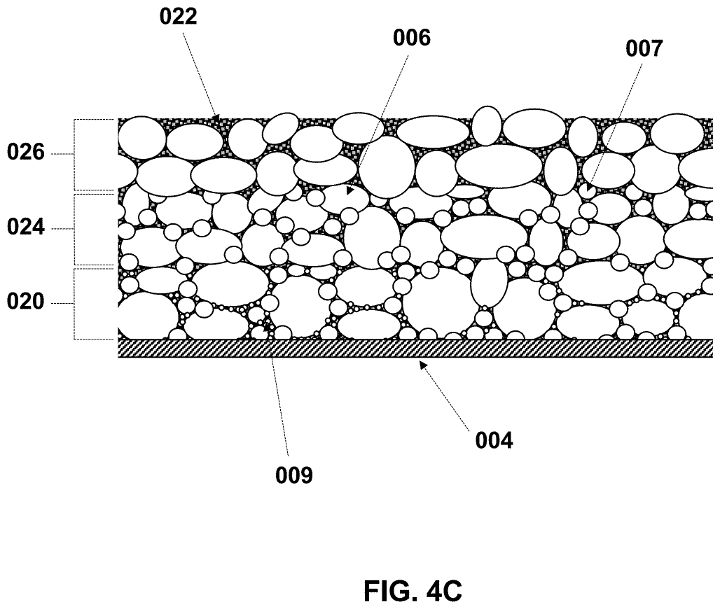

FIG. 4A: A schematic illustration of a first catholyte gradient layer (020), wherein the gradient layer is formed onto a current collector (004), wherein the first catholyte gradient layer is formed using a composite cathode powder formulation with a wide active cathode material particle size range and minimal catholyte of small particle size (022), wherein the space between large (006) and medium (007) size active particles are filled with smaller active particles (009).

FIG. 4B: A schematic illustration of a catholyte gradient composite cathode structure, wherein a first catholyte gradient layer (020) is formed onto a current collector (004) and a second catholyte gradient layer (024) is formed onto the first catholyte gradient layer, wherein the second catholyte gradient layer is formed using a composite cathode powder formulation with a narrower active cathode material particle size range and a higher catholyte (022) content with a larger particle sizes than the first catholyte gradient layer, wherein the second catholyte gradient layer is composed of large (006) and medium (007) sized active materials, and catholyte (022) located in the space between the active particles.

FIG. 4C: A schematic illustration of a catholyte gradient composite cathode structure, wherein a first catholyte gradient layer (020) is formed onto a current collector (004), a second catholyte gradient layer (024) is formed onto the first catholyte gradient layer, and a third catholyte gradient layer (026) is formed onto the second catholyte gradient layer, wherein the third catholyte gradient layer is formed using a composite cathode powder formulation with a narrower active cathode material particle size range and a higher catholyte content (022) with larger particle sizes than the second catholyte gradient layer, wherein the third catholyte gradient layer is composed of large (006) sized and catholyte (022) located in the space between the active particles.

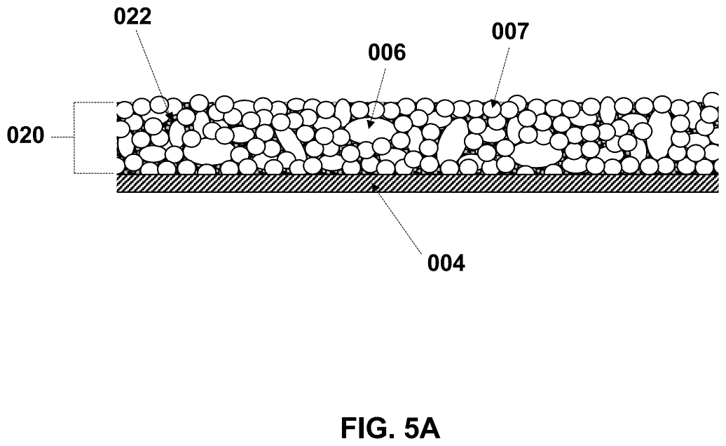

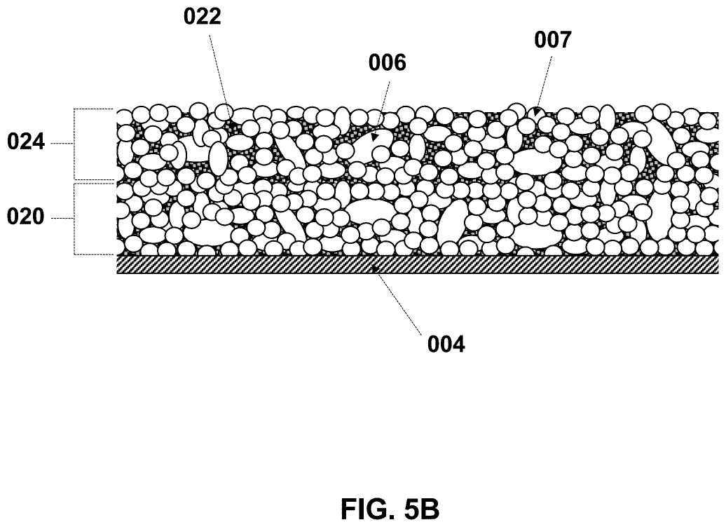

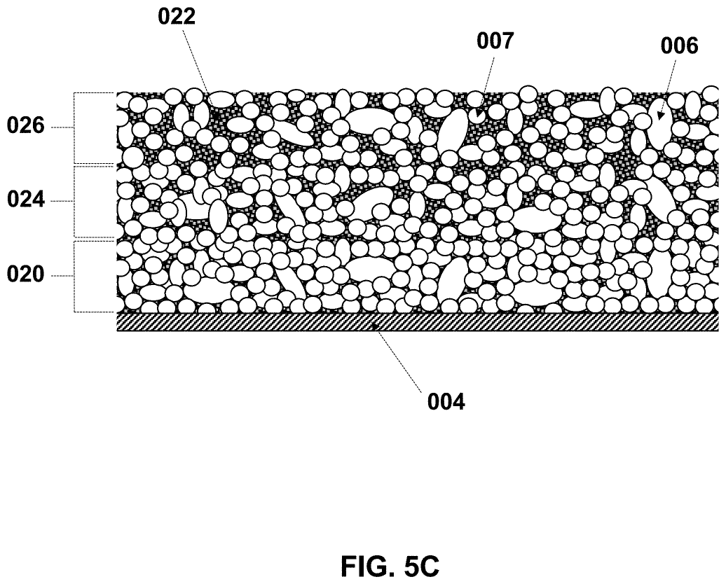

FIG. 5A: A schematic illustration of a first catholyte gradient layer (020), wherein the gradient layer is formed onto a current collector (004), wherein the first catholyte gradient layer is formed using a composite cathode powder formulation with large (006) and medium (007) sized active particles and minimal catholyte (022), wherein the space between the active particles is filled with catholyte (022).

FIG. 5B: A schematic illustration of a catholyte gradient composite cathode structure, wherein a first catholyte gradient layer (020) is formed onto a current collector (004) and a second catholyte gradient layer (024) is formed onto the first catholyte gradient layer, wherein the second catholyte gradient layer is formed using a composite cathode powder formulation with large (006) and medium (007) sized active particles, and a higher catholyte (022) content of similar particle size than the first catholyte gradient layer, wherein the space between the active particles is filled with catholyte (022).

FIG. 5C: A schematic illustration of a catholyte gradient composite cathode structure, wherein a first catholyte gradient layer (020) is formed onto a current collector (004), a second catholyte gradient layer (024) is formed onto the first catholyte gradient layer, and a third catholyte gradient layer (026) is formed onto the second catholyte gradient layer, wherein the third catholyte gradient layer is formed using a composite cathode powder formulation with large (006) and medium (007) sized active particles, and a higher catholyte (022) content of similar particle size than the second catholyte gradient layer, wherein the space between the active particles is filled with catholyte (022).

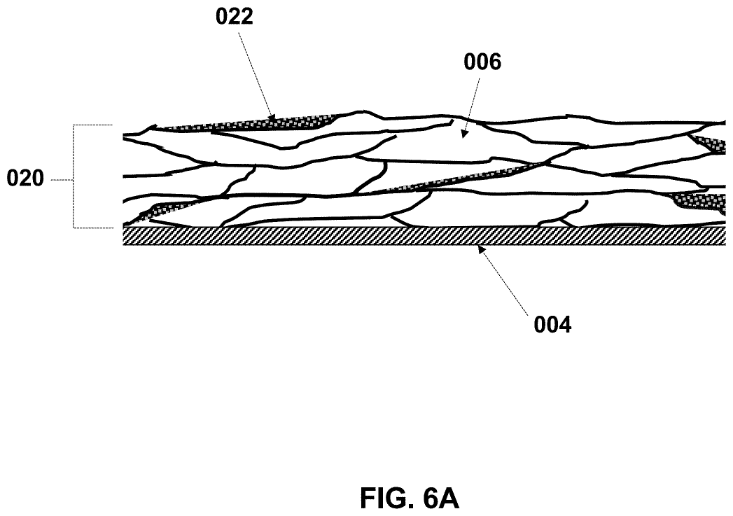

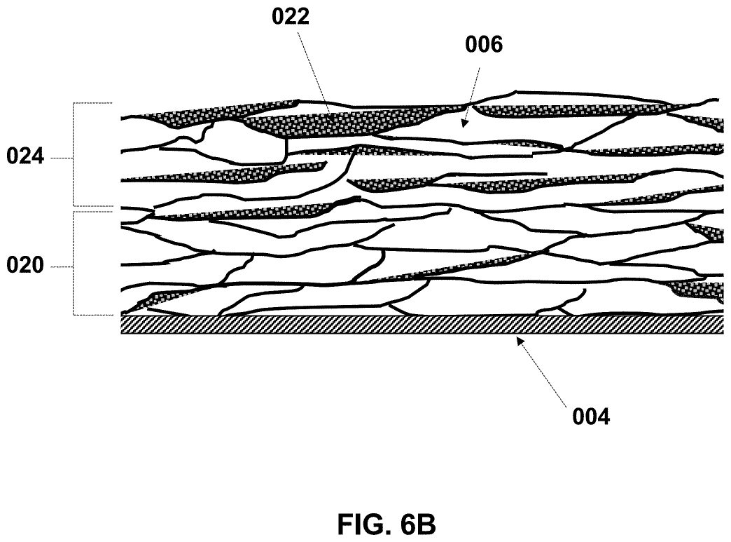

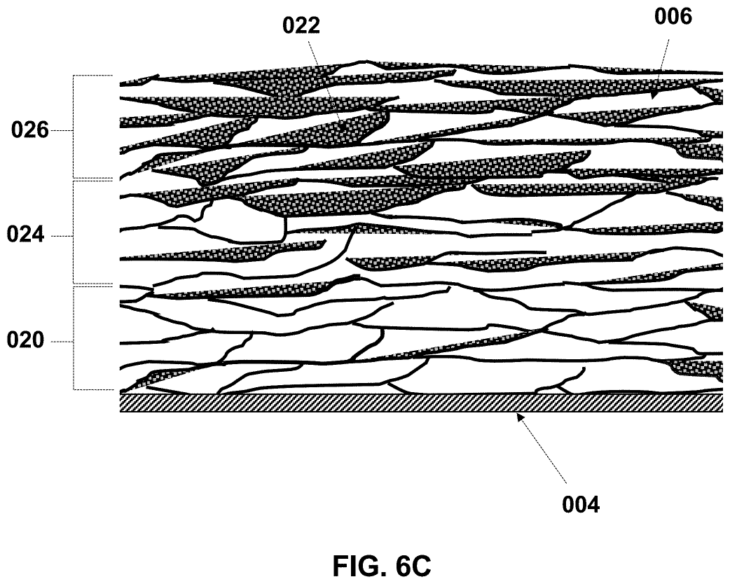

FIG. 6A: A schematic illustration of a first catholyte gradient composite cathode layer (020), wherein the gradient layer is formed onto a current collector (004), wherein the first catholyte gradient layer is formed using a composite cathode powder formulation with minimal catholyte (022), wherein the first catholyte gradient layer is composed of densely layered or lamella active (016) and catholyte (022) materials formed using a high plasma energy (via plasma spray) or a high pressure or powder flow rates (via cold spray).

FIG. 6B: A schematic illustration of a catholyte gradient composite cathode structure, wherein a first catholyte gradient layer (020) is formed onto a current collector (004) and a second catholyte gradient layer (024) is formed onto the first catholyte gradient layer, wherein the second catholyte gradient layer is formed using a composite cathode powder formulation with a higher catholyte (022) than the first catholyte gradient layer, wherein the second catholyte gradient layer is composed of densely layered or lamella active (016) and catholyte (022) materials formed using a high plasma energy (via plasma spray) or a high pressure or powder flow rates (via cold spray).

FIG. 6C: A schematic illustration of a catholyte gradient composite cathode structure, wherein a first catholyte gradient layer (020) is formed onto a current collector (004), a second catholyte gradient layer (024) is formed onto the first catholyte gradient layer, and a third catholyte gradient layer (026) is formed onto the second catholyte gradient layer, wherein the third catholyte gradient layer is formed using a composite cathode powder formulation with a higher catholyte (022) content than the second catholyte gradient layer, wherein the third catholyte gradient layer is composed of densely layered or lamella active (016) and catholyte (022) materials formed using a high plasma energy (via plasma spray) or a high pressure or powder flow rates (via cold spray).

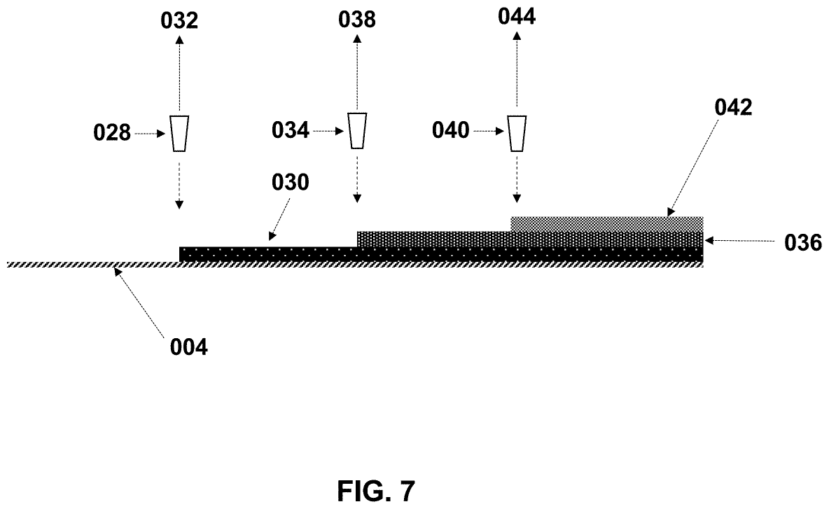

FIG. 7: A schematic illustration of a roll-to-roll processing method for porosity gradient and catholyte gradient cathode and composite cathode structures, wherein a first high-throughput spray gun (028) is used to form a first gradient layer (030) onto a rolling current collector (004) using a first cathode or composite cathode powder formulation feedstock. A second high-throughput spray gun (034) is used to form a second gradient layer (036) onto a rolling current collector (004) using a second cathode or composite cathode powder formulation feedstock (038). A third high-throughput spray gun (040) is used to form a third gradient layer (042) onto a rolling current collector (004) using a third cathode or composite cathode powder formulation feedstock (044).

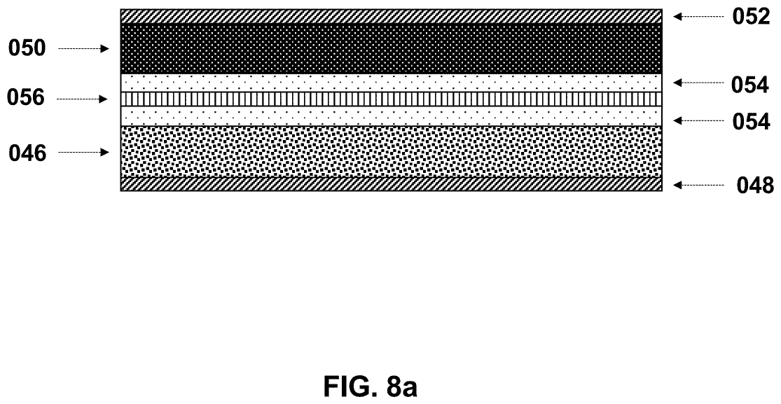

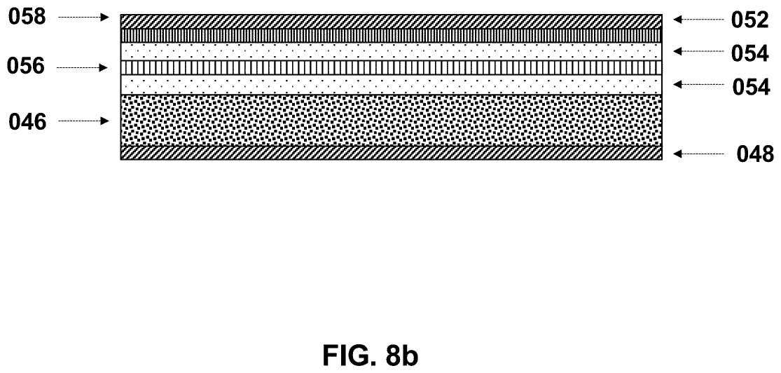

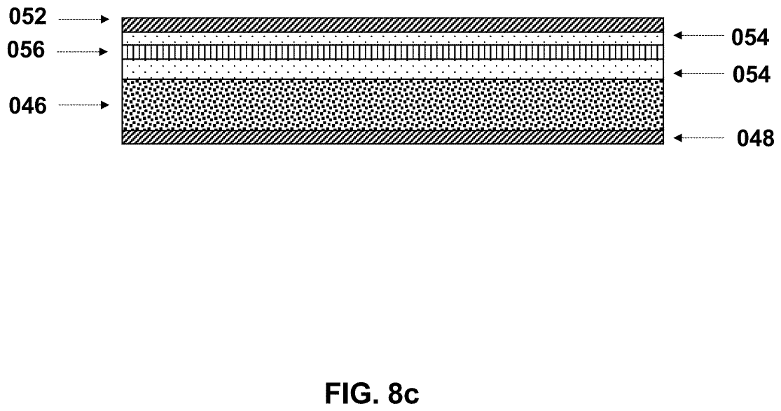

FIG. 8a: A schematic illustration of a lithium battery comprising of a porosity gradient cathode (046) formed onto a positive current collector (048), wherein the lithium battery further comprises of an anode (050), formed onto a negative current collector (052), a liquid-based electrolyte (054), and a porous separator (056). An anode may comprise of an active material that interacts with lithium ions through an intercalation mechanism, alloy mechanism, conversion mechanism, or a combination thereof.

FIG. 8b: A schematic illustration of a lithium battery comprising of a porosity gradient cathode (046) formed onto a positive current collector (048), wherein the lithium battery further comprises of an lithium metal-based anode (058), formed onto a negative current collector (052), a liquid-based electrolyte (054), and a porous separator (056). A lithium metal-based anode may be coated with a protective layer acting as an artificial solid electrolyte interface.

FIG. 8c: A schematic illustration of a lithium battery comprising of a porosity gradient cathode (046) formed onto a positive current collector (048), wherein the lithium battery is an anodeless lithium battery comprises of a negative current collector (052), a liquid-based electrolyte (054), and a porous separator (056).

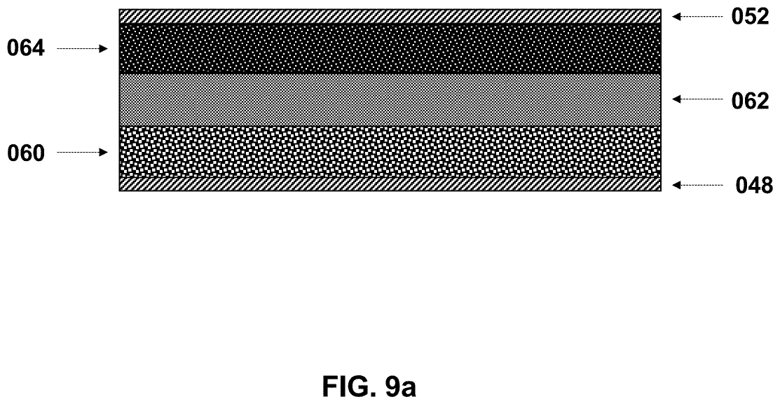

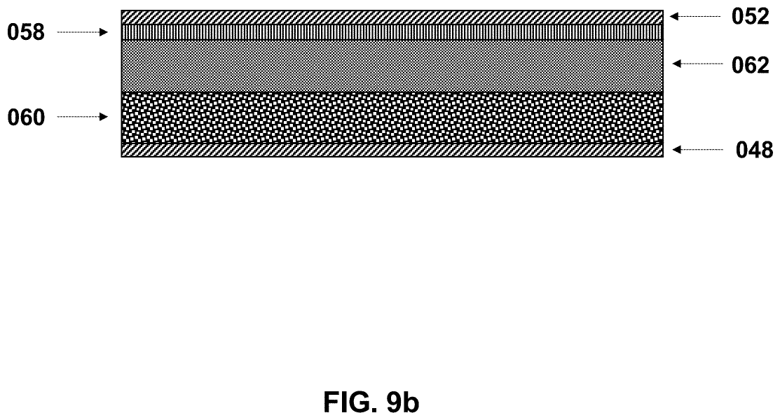

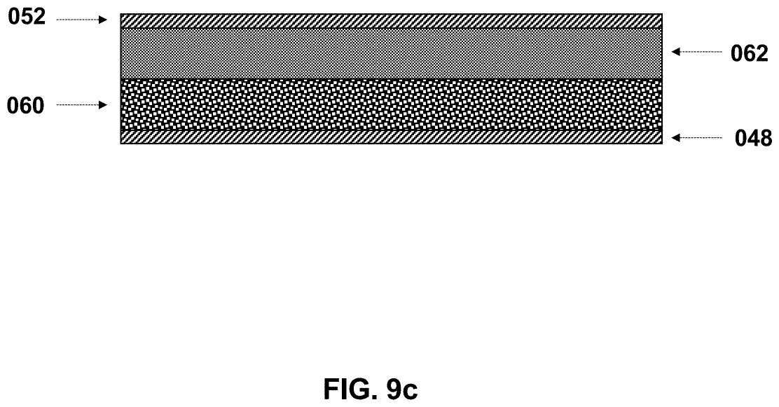

FIG. 9a: A schematic illustration of a solid-state lithium battery comprising of a catholyte gradient composite cathode (060) formed onto a positive current collector (048), wherein the solid-state lithium battery further comprises of an composite anode (064), formed onto a negative current collector (052), and a solid-state electrolyte (062). A composite anode may comprise of an active material that interacts with lithium ions through an intercalation mechanism, alloy mechanism, conversion mechanism, or a combination thereof.

FIG. 9b: A schematic illustration of a solid-state lithium battery comprising of a catholyte gradient composite cathode (060) formed onto a positive current collector (048), wherein the solid-state lithium battery further comprises of a lithium metal-based anode (058), formed onto a negative current collector (052), and a solid-state electrolyte (062). A lithium metal-based anode may be coated with a protective layer acting as an artificial solid electrolyte interface.

FIG. 9c: A schematic illustration of a solid-state lithium battery comprising of a catholyte gradient composite cathode (060) formed onto a positive current collector (048), wherein the solid-state lithium battery is an anodeless solid-state lithium battery comprises of a negative current collector (052) and a solid-state electrolyte (062).

The above-described systems and methods can be ascribed to lithium-based secondary batteries such as, but not limited to, lithium-ion batteries, lithium metal batteries, all-solid-state lithium batteries, aqueous batteries, lithium polymer batteries, etc.

The above-described systems and methods can be ascribed to secondary batteries with chemistries beyond lithium, which may include sodium ion, aluminum ion, magnesium ion, iron ion, potassium ion, etc.

The above-described systems and methods can be ascribed to various secondary battery designs such as, but not limited to, pouch cell, coil cell, button cell, cylindrical cell, prismatic cell, etc.

The above-described systems and methods can be ascribed to secondary batteries with the end use applications such as, but not limited to, electric vehicles, hybrid electric vehicles, mobile devices, handheld electronics, consumer electronics, medical, medical wearables, and wearables for portable energy storage.

The above-described systems and methods can be ascribed to secondary batteries for grid scale energy storage backup systems.

The above-described systems and methods can be ascribed to secondary batteries for longevity, higher energy density and power density and improved safety.

The above-described systems and methods can be ascribed for alternative energy storage technologies such as primary batteries and flow batteries.

In the drawings, the following reference numbers are noted:
002 First porosity gradient layer
004 Current collector
006 Large active cathode particles
007 Medium size active cathode particles
008 Porosity
009 Small active cathode particles
010 Second porosity gradient layer
012 Third porosity gradient layer
014 Polymer
016 Dense layer or lamella structure
018 Granular structure
020 First catholyte gradient layer
022 Catholyte
024 Second catholyte gradient layer
026 Third catholyte gradient layer
028 First high-throughput spray gun
030 First gradient layer
032 First cathode/composite cathode powder formulation
034 Second high-throughput spray gun
036 Second gradient layer
038 Second cathode/composite cathode powder formulation
040 Third high-throughput spray gun
042 Third gradient layer
044 Third cathode/composite cathode powder formulation
046 Porosity gradient cathode
048 Positive current collector
050 Anode
052 Negative current collector
054 Liquid-based electrolyte
056 Porous Separator
058 Li metal-based anode
060 Catholyte gradient composite cathode
062 Solid-state electrolyte
064 Composite anode

Although various embodiments of the disclosed gradient multilayer structures for lithium batteries, methods for manufacturing thereof, and lithium batteries comprising gradient multilayer structures have been shown and described, modifications may occur to those skilled in the art upon reading the specification. The present application includes such modifications and is limited only by the scope of the claims.

1. A method for manufacturing a multilayer structure for a lithium battery, the method comprising:
forming a first layer comprising an active material and a first porosity; and
forming a second layer on the first layer, the second layer comprising an active material and a second porosity, wherein the first porosity is different from the second porosity.

2. The method of claim 1, wherein the first layer is formed by energy-assisted spray deposition.

3. The method of claim 2, wherein the energy-assisted spray deposition comprises thermal spray deposition.

4. The method of claim 2, wherein the energy-assisted spray deposition comprises cold spray deposition.

5. The method of claim 1, wherein the first layer is formed on a current collector.

6. The method of claim 1, wherein the first layer is formed on a negative current collector.

7. The method of claim 1, wherein the first layer is formed on a positive current collector.

8. A method for manufacturing a multilayer structure for a lithium battery, the method comprising:
forming a first layer comprising an active material and a first amount of solid-state ionic conductive material; and
forming a second layer on the first layer, the second layer comprising an active material and a second amount of solid-state ionic conductive material, wherein the first amount of solid-state ionic conductive material is different from the second amount of solid-state ionic conductive material.

9. The method of claim 8, wherein the first layer is formed by energy-assisted spray deposition.

10. The method of claim 9, wherein the energy-assisted spray deposition comprises thermal spray deposition.

11. The method of claim 9, wherein the energy-assisted spray deposition comprises cold spray deposition.

12. The method of claim 9, wherein the first layer is formed on a current collector.

13. The method of claim 9, wherein the first layer is formed on a negative current collector.

14. The method of claim 9, wherein the first layer is formed on a positive current collector.

15. The method of claim 9, wherein the first layer is formed on a solid state electrolyte layer.

16. The method of claim 9, wherein the solid-state ionic conductive material is a catholyte material.

17. The method of claim 9, wherein the solid-state ionic conductive material is an anolyte material.

18. A multilayer structure for a lithium battery, the multilayer structure comprising:
a current collector; and
a multilayer structure on the current collector, the multilayer structure comprising a plurality of layers comprising an active material and porosity, wherein the multilayer structure has a porosity gradient with respect to adjacent layers of the multilayer structure.

19. The multilayer structure of claim 18, wherein the multilayer structure is formed by energy-assisted spray deposition.

20. The multilayer structure of claim 19, wherein the energy-assisted spray deposition comprises thermal spray deposition.

21-34. (canceled)
